(19) United States
(12) Patent Application Publication
(10) Pub. No.: US 2026/0210859 A1
(43) Pub. Date: Jul. 23, 2026

(54) POLARIZED FOURIER LIGHT-FIELD IMAGING

(71) Applicant: California Institute of Technology, Pasadena, CA (US)

(72) Inventors: Oumeng Zhang, Pasadena, CA (US); Changhuei Yang, South Pasadena, CA (US)

(73) Assignee: California Institute of Technology, Pasadena, CA (US)

(21) Appl. No.: 19/456,974

(22) Filed: Jan. 22, 2026

Related U.S. Application Data
(60) Provisional application No. 63/748,266, filed on Jan. 22, 2025.

(51) Int. Cl. G01N 21/64

(52) U.S. Cl. CPC G01N 21/6458; G01N 21/6445; G01N 2021/6478

(57) ABSTRACT

Polarized Fourier light field imaging that involve a microlens array segmenting fluorescence emissions at different angles, an optical configuration that converts the fluorescence emissions into spatial frequencies in the Fourier domain, and a polarization sensor that can acquire a raw image including polarized sub-images corresponding to polarization channels.

### CROSS-REFERENCE TO RELATED APPLICATION

This application claims benefit of and priority to U.S. Provisional Patent Application No. 63/748,266, titled “Five-Dimensional Single-Shot Fluorescence Imaging Using a Polarized Fourier Light-Field Microscope,” and filed on Jan. 22, 2025, which is incorporated by reference herein in its entirety and for all purposes.

### FIELD

Certain aspects relate generally to volumetric fluorescence imaging, and more specifically, to volumetric fluorescence imaging methods and systems that implement polarized Fourier light field imaging techniques.

### BACKGROUND

Fluorescence imaging is one of the most effective optical imaging techniques used across various fields, including biological, biochemical, biomedical, and environmental studies, where it provides unparalleled insights due to its high specificity and sensitivity. Traditional volumetric fluorescence imaging techniques, such as confocal or light-sheet microscopy, typically rely on scanning to acquire the data needed to reconstruct three-dimensional fluorescence structure images. Scanning can not only complicate the imaging system by requiring multiple moving parts, but also extends the time required for data acquisition.

Background and contextual descriptions contained herein are provided solely for the purpose of generally presenting the context of the disclosure. Much of this disclosure presents work of the inventors, and simply because such work is described in the background section or presented as context elsewhere herein does not mean that such work is admitted prior art.

### SUMMARY

Certain techniques disclosed herein may be practiced with a processor-implemented method, a system comprising one or more processors and one or more processor-readable media, and/or one or more non-transitory processor-readable media.

Certain embodiments pertain to polarized Fourier light-field imaging systems. In various implementations, a polarized Fourier light-field imaging system includes a first optical system in optical communication with one or more light sources. The first optical system is configured to deliver polarized excitation illumination to a sample being imaged, the sample issuing fluorescence emissions induced by the polarized excitation illumination. The first optical system including a microlens array at a pupil plane, the microlens array comprising a plurality of lenslets configured to segment fluorescence emissions issuing from the sample from different angles. The polarized Fourier light-field imaging system also includes a second optical system in optical communication with the microlens array. The second optical system is configured to convert the fluorescence emissions into spatial frequencies in the Fourier domain. The polarized Fourier light-field imaging system also includes a polarization sensor (e.g., of a polarization camera) in optical communication with the second optical system. The polarization sensor is configured to acquire one or more raw images, each raw image including a plurality of polarized sub-images corresponding to a respective plurality of polarization channels.

Certain embodiments pertain to polarized Fourier light-field imaging methods. In various implementations, a polarized Fourier light-field imaging method includes obtaining a raw image of a sample using a polarization camera. The raw image includes a plurality of polarized two-dimensional (2D) sub-images corresponding to a plurality of polarization channels associated with polarization angles of polarized pixels of the polarization camera, the raw image acquired based on fluorescence emissions emitted from fluorophores in the sample in response to activation by polarized excitation illumination. The polarized Fourier light-field imaging method also includes applying a 2D-to-3D reconstruction procedure to the plurality of 2D polarized sub-images to generate a corresponding plurality of three-dimensional (3D) volumetric datasets. The polarized Fourier light-field imaging method also includes applying voxel-wise combination of the plurality of 3D volumetric datasets based on Stokes relationships to generate a volumetric fluorescence image.

These and other features and embodiments will be described in more detail with reference to the drawings.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a simplified block diagram of components of an example of a polarized Fourier light field (pFLF) imaging system, according to embodiments

FIG. 2 is a schematic drawing of components of a pFLF imaging system, according to embodiments.

FIG. 3 is a schematic drawing of components of the pFLF imaging system in FIG. 2.

FIG. 4 is a schematic drawing of a plan view of a polarization sensor of the polarization camera in FIG. 2, according to various embodiments.

FIG. 5 is an image of four lenslets of the microlens array of the pFLF imaging system in FIG. 2, according to an implementation.

FIG. 6 depicts a raw image of a wheat root captured by an implementation of the pFLF imaging system shown in FIG. 2, according to an embodiment.

FIG. 7 is an illustration of an example of point spread functions (PSFs) experimentally determined for the pFLF imaging system in FIG. 2, according to an embodiment.

FIG. 8 depicts a flowchart depicting an example polarized Fourier light field (pFLF) imaging method, according to various embodiments.

FIG. 9 depicts a flowchart depicting an example polarized Fourier light field (pFLF) imaging method, according to various embodiments.

FIG. 10 is an illustration including reconstructed pFLF images of a fluorescent Siemens star under in-focus, varying defocus, and fluorescence polarizations of 0°, 22.5°, 45°, 67.5°, and 90°, according to an embodiment.

FIG. 11A is a plot of the lateral resolution at different z-depths for various fluorescence polarizations, according to an embodiment.

FIG. 11B is a plot of estimation bias (Zₑₛₜ-Z) as a function of defocus for isotropic fluorescence and linearly-polarized fluorescence at different polarizations angles, according to an embodiment.

FIG. 12 is an illustration including reconstructed pFLF images of wheat root sections, according to an implementation.

FIG. 13 is an illustration including reconstructed pFLF images of wheat root sections, according to an implementation.

FIG. 14 is an illustration including reconstructed pFLF images of wheat root sections, according to an implementation.

FIG. 15 is an illustration including pFLF images of zoomed in regions in FIGS. 12 and 13 at the sharpest focal depths, according to an implementation.

FIG. 16 depicts a block diagram of an example of a computing device, according to various embodiments.

FIG. 17 depicts a block diagram of an example of a computing device, according to various embodiments.

The figures and components therein may not be drawn to scale.

### DETAILED DESCRIPTION

Different aspects are described below with reference to the accompanying drawings. In the following description, numerous specific details are set forth in order to provide a thorough understanding of the presented embodiments. The disclosed embodiments may be practiced without one or more of these specific details. In other instances, well-known operations have not been described in detail to avoid unnecessarily obscuring the disclosed embodiments. While the disclosed embodiments will be described in conjunction with the specific embodiments, it will be understood that it is not intended to limit the disclosed embodiments.

### I. Polarized Fourier Light Field Imaging

Traditional volumetric fluorescence imaging techniques such as confocal or light-sheet microscopy rely on scanning to acquire the data needed to reconstruct three-dimensional (3D) fluorescence structure images. Scanning can not only complicate the imaging system by requiring multiple moving parts, but also extends the time required for data acquisition. With their reliance on scanning, traditional volumetric fluorescence imaging approaches typically require time-intensive data acquisition procedures and mechanically complex imaging systems.

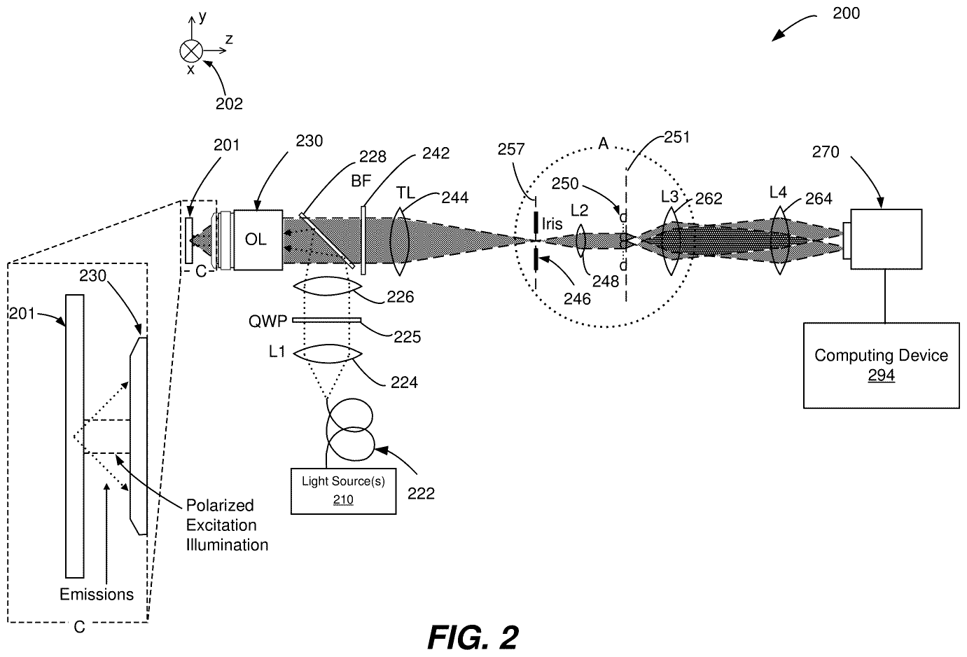

According to various embodiments, polarized Fourier light field (pFLF) imaging methods and systems (sometimes referred to herein as “pFLF techniques” or “pFLF imaging techniques”) involve volumetric fluorescence imaging with acquisition of five-dimensional (5D) data including 3D fluorescence intensity data (x, y, and z) and two-dimensional (2D) polarization data (in plane perpendicular to the direction of light propagation) in a single snapshot. These single-shot volumetric fluorescence imaging techniques have the ability to rapidly capture complex biological data without the need for extensive scanning. This single-shot approach can be transformative for applications that require high-speed and multidimensional imaging, such as with live biological and environmental studies where capturing spatial and biochemical heterogeneities in real-time is essential. Polarized Fourier light field imaging microscopy (pFLFM) implements certain pFLF techniques. An illustrated example of a Fourier light field imaging microscope is shown in, and described with respect to, FIGS. 2-4.

Polarized Fourier light field (pFLF) imaging can provide significant advancement in fluorescence imaging by enabling measurement of polarization-resolved properties of fluorescence emission, in addition to conventional intensity-based imaging. Polarization measurements are of particular significance because these measurements can provide insights into the orientation of fluorophores in the sample, which can reveal details about the local biochemical and biophysical environment. Some examples of techniques that use polarization measurements can be found in Brasselet S., and Alonso, M. A., “Polarization microscopy: from ensemble structural imaging to single-molecule 3D orientation and localization microscopy,” Optica 10(11), 1486 (2023) and Zhang O. and Lew, M. D., “Single-molecule orientation-localization microscopy: Applications and approaches,” Quart. Rev. Biophys. 57, e17 (2024). Briefly, fluorescent molecules can be modeled as oscillating dipoles that emit polarized light, with the emission polarization depending on the orientation of the dipole. Examples of these models can be found in Axelrod, D., “Fluorescence excitation and imaging of single molecules near dielectric-coated and bare surfaces: a theoretical study,” Journal of Microscopy 247 (2), 147-160 (2012) and Backer A. S. and Moerner, W. E. “Extending Single-Molecule Microscopy Using Optical Fourier Processing,” The Journal of Physical Chemistry B 118 (28), pages 8313-8329 (2014). When fluorophores are randomly oriented within the sample, the resulting fluorescence emission is typically isotropic, showing no preferred polarization direction. In contrast, when fluorophores are more orderly arranged within the local environment, a strong polarization preference in the emitted fluorescence is observed, indicating the structured alignment of these fluorophores. This polarization property has been used to explore various biological phenomena, such as chemical heterogeneities within lipid membranes, the growth and decay of amyloid fibrils, and conformational changes in DNA structures. Examples regarding chemical heterogeneities within lipid membranes can be found in Lu, J., Mazidi, H., Ding, T., Zhang, O., and Lew, M. D., “Single-Molecule 3D Orientation Imaging Reveals Nanoscale Compositional Heterogeneity in Lipid Membranes,” Angewandte Chemie International Edition 59 (40), pages 17572-17579 (2020), Zhang, O., Zhou, W., Lu, J., Wu, T., and Lew, M. D., “Resolving the Three-Dimensional Rotational and Translational Dynamics of Single Molecules Using Radially and Azimuthally Polarized Fluorescence,” Nano Letters 22 (3), pages 1024-1031 (2022), and Zhang, O., Guo, Z., He, Y., Wu, T., Vahey, M. D. and Lew, M. D., “Six-dimensional single-molecule imaging with isotropic resolution using a multi-view reflector microscope,” Nature Photonics 17 (2), pages 179-186 (2023). An example regarding the growth and decay of amyloid fibrils can be found in Sun, B., Ding, T., Zhou, W., Porter, T. S., and Lew, M. D., “Single-Molecule Orientation Imaging Reveals the Nano-Architecture of Amyloid Fibrils Undergoing Growth and Decay,” Nano Lett. 24 (24), pages 7276-7283 (2024). An example regarding conformational changes in DNA structures can be found in Backer, A. S., Biebricher, A. S., King, G. A., Wuite, G. J. L., Heller, I., and Peterman, E. J. G., “Single-molecule polarization microscopy of DNA intercalators sheds light on the structure of S-DNA,” Sci. Adv. 5 (3), eaav1083 (2019).

In various embodiments, pFLF techniques employ a polarization camera that can capture five-dimensional (5D) data including 3D fluorescence intensity data (x, y, and z) and 2D polarization data in a single-shot (at one acquisition time). The 2D polarization data may include measurements of an angle of linear polarization (AoLP) and/or a degree of linear polarization (DoLP), for example. As used herein, an “angle of linear polarization” or “AoLP” generally refers to the orientation angle of the linearly polarized component of detected light relative to a defined reference axis (e.g., the x-axis of a detector or image plane). The AoLP can provide information about the sample structure and/or emitter orientation, including information related to local geometry such as a surface normal of a fluorescently emitting region. As used herein, a “degree of linear polarization” or “DoLP” refers to a ratio of intensity of polarized part of light to intensity of both polarized and unpolarized parts of light. DoLP is typically within a range from 0 to 1, where DoLP=0 corresponds to unpolarized light and DoLP=1 corresponds to fully linearly polarized light. The pFLF techniques use the polarization camera to capture one or more raw images. Each raw image includes multiple two-dimensional (2D) polarized sub-images corresponding to pixel intensities of the polarization camera along different polarization axes (e.g., polarization axes 0°, 45°, 90°, and) 135°. The polarized sub-images correspond to different respective polarization channels output from the polarization camera. A 3D volumetric dataset can be generated from each polarized sub-image along with the PSF (point spread function) using a 2D-to-3D reconstruction procedure such as a Richardson-Lucy (RL) deconvolution procedure, a sparsity-regularized RL deconvolution procedure, a neural fields representation procedure, etc. A voxel-wise combination of the 3D volumetric intensity datasets based on Stokes relationships defined in Eqns. 1A-C, 2, and 3 below can be applied to generate a volumetric fluorescence image with 3D fluorescence intensity data and 2D polarization data such as AoLP and DoLP data.

The first, second, and third Stokes parameters for linear polarized light are defined as follows:

$${S}_{0} = {P}_{0 °} + {P}_{90 °} \qquad ( Eqn . 1 A )$$

$${S}_{1} = {P}_{0 °} - {P}_{90 °} \qquad ( Eqn . 1 B )$$

$${S}_{2} = {P}_{45 °} - {P}_{135 °} \qquad ( Eqn . 1 C )$$

where P_{0°} is the polarized pixel intensity at polarization angle 0°, P_{90°} is the polarized pixel intensity along 90°, P_{45°} is the polarized pixel intensity at polarization angle 45°, and P_{135°} is the polarized pixel intensity along 135°

The degree of linear polarization (DoLP) is defined as:

$$D o L P = \frac{\sqrt{{S}_{1}^{2} + {S}_{2}^{2}}}{{S}_{1}} \qquad ( Eqn . 2 )$$

The angle of linear polarization (AoLP) is defined as:

$$A o L P = {tan}^{- 1} ( \frac{{S}_{2}}{{S}_{1}} ) \qquad ( Eqn . 3 )$$

The pFLF techniques of various embodiments can provide one or more advantageous improvements over conventional imaging. For example, the pFLF techniques can capture both spatial (3D intensity distribution) and biochemical (polarization) data simultaneously, which is beyond the capability of conventional volumetric fluorescence imaging. The polarization information can be used to reveal fluorophore orientation and structural organization, offering insights into the local biochemical and biophysical environments. As another example, pFLF systems have enhanced depth of field over conventional 2D microscopy due to its optical setup in which a microlens array is positioned at a pupil to partition the pupil into multiple subapertures that form multiple elemental views with reduced effective numerical aperture per view and enable computational refocusing/3D reconstruction over an extended depth of field. In addition, pFLF systems can have a simplified and compact design. By utilizing a microlens array (MLA) at the pupil plane and a polarization camera, pFLF systems have reduced mechanical complexity over traditional volumetric fluorescence microscopy and have the potential for miniaturization. This makes pFLF systems more suitable for in-vivo applications than bulky and moving part-dependent alternatives. pFLF techniques also have particular relevance in biological studies. For example, the pFLF system 200 in FIG. 2 has demonstrated utility in imaging plant roots as discussed in Section IV, revealing unique cellulose fibril orientations and structural heterogeneities based on the polarization information. Such insights are challenging to achieve with existing imaging methods. In addition, with conventional 3D reconstruction that does not utilize polarization information, inaccurate or biased structures may be generated as discussed in Lew, Matthew D., Mikael P. Backlund, and W. E. Moerner. “Rotational mobility of single molecules affects localization accuracy in super-resolution fluorescence microscopy.” Nano letters 13.9 (2013): 3967-3972. By using polarization information, pFLF techniques can provide more accurate 3D measurements than imaging techniques based on conventional 3D reconstruction without polarization data.

The pFLF techniques described herein may have various applications in, for example, biomedical imaging, environmental science, and industrial use. For example, certain pFLF techniques can be used in biological imaging to study cellular structures, such as the alignment of amyloid fibrils, lipid membranes, and DNA conformations, which are linked to critical biological processes and diseases. As another example, certain pFLF techniques can be used in environmental science to investigate the organization of cellulose fibrils in plants to understand growth patterns and environmental responses. As another example, certain pFLF techniques can be used in industrial use to characterize polarization-sensitive materials or systems, such as liquid crystals in display technologies. Generally speaking, the pFLF techniques represent a significant leap in fluorescence imaging by merging high-dimensional data acquisition with simplicity and efficiency, opening doors to new possibilities in multidimensional imaging across various scientific and industrial fields.

### II. Polarized Fourier Light Field Imaging Systems

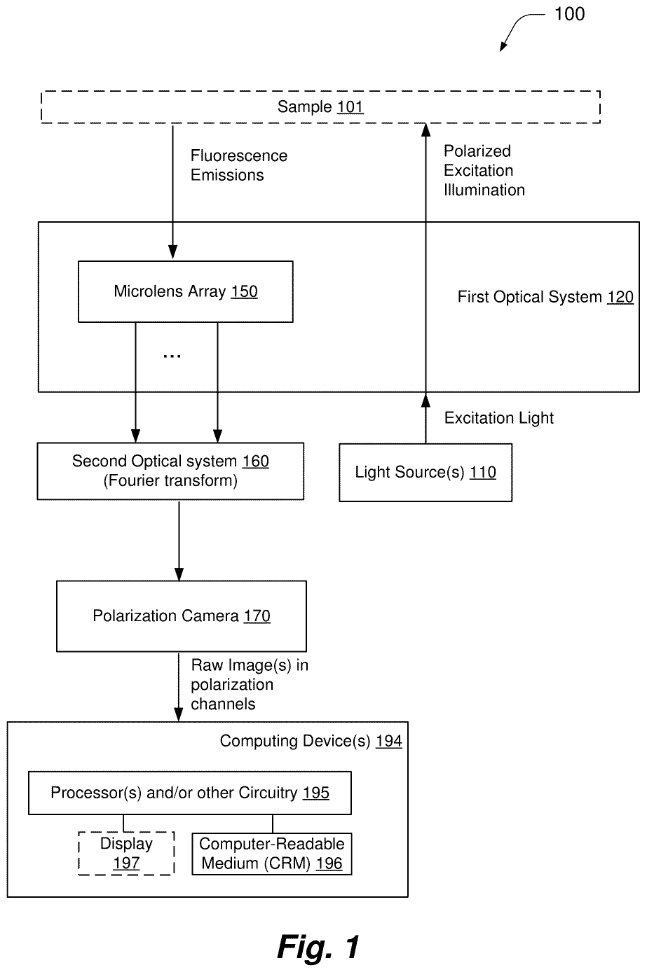

FIG. 1 is a simplified block diagram of components of an example of a polarized Fourier light field (pFLF) imaging system 100, according to embodiments. The pFLF imaging system 100 includes one or more light sources 110 operable to emit excitation light of a range of wavelengths for activating fluorophores in a sample 101 being imaged. In response, the activated fluorophores in the sample 101 emit fluorescence emissions. The pFLF imaging system 100 also includes a first optical system 120 in optical communication with the light source(s) 110. The first optical system 120 includes a plurality of optical elements including a microlens array 150 positioned at a pupil plane. Certain optical elements of the first optical system 120 are configured to create polarized excitation illumination and deliver the polarized excitation illumination to the sample 101. Certain optical elements of the first optical system 120 are configured to propagate fluorescence emissions from the sample 101 to lenslets of the microlens array 150. The lenslets of the microlens array 150 are positioned to capture fluorescence emissions issuing from the sample 101 from different angles. During reconstruction, fluorescence emissions from different angles are treated as multiple measurements of the same underlying 3D fluorescence distribution. A forward imaging model based on a calibrated 3D point-spread function for each microlens predicts the sub-images that would be observed for a candidate 3D volume from that angle, and a reconstruction algorithm solves the 3D volume until the predicted sub-images match the measured sub-images across all views. When the pFLF imaging system 100 is not in operation, the sample 101 may optionally not be present (as denoted by the dashed line).

The pFLF imaging system 100 also includes a second optical system 160 in optical communication with the microlens array 150 and a polarization camera 170 in optical communication with the second optical system 160. The polarization camera 170 can capture one or more raw images of the sample 101. In some cases, the first optical system 120 may include an iris (e.g., iris 246 shown in and described with respect to FIG. 2) at an intermediate image plane to set the field-of-view of the images acquired by the polarization camera 170.

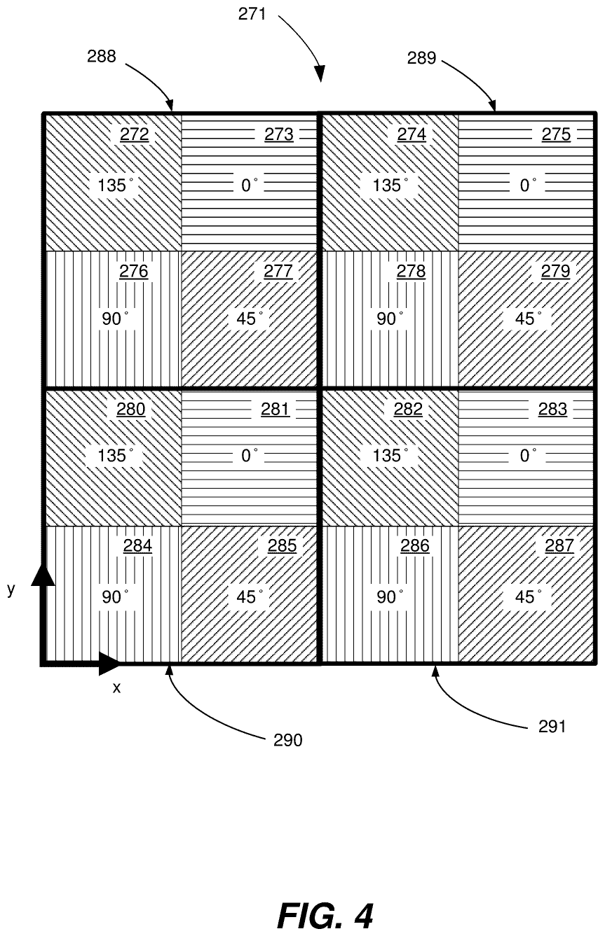

The polarization camera 170 includes a plurality of polarized pixels, where each polarized pixel takes intensity measurements at a polarization angle. In some cases, the polarization camera 170 includes an array of polarized pixels that include a plurality of groups of polarized pixels (pixel blocks), each pixel block including a plurality of polarized pixels for taking intensity measurements at respective polarization angles (sometimes referred to herein as “polarizations”). For instance, the polarization camera 170 may include an array of polarized pixels including pixel blocks of four polarized pixels (four-pixel blocks) for measuring intensities at four polarization angles (e.g., 0°, 45°, 90°, and) 135°. The polarization angles are measured with reference to a local x-axis (e.g., x-axis shown in FIG. 4) at a plane at the sensing surface of the polarization camera 170.

The polarization camera 170 includes a plurality of polarization channels that capture intensity measurements of polarized light at different polarization angles based on intensities measured by the polarized pixels. Each polarization channel provides intensities for one polarization angle. For instance, the polarization camera 170 may include a 0° polarization channel that captures intensity measurements of polarized light at a 0° polarization angle, a 45° polarization channel that captures intensity measurements of polarized light at 45° polarization angle, a 90° polarization channel that captures intensity measurements of polarized light at 90° polarization angle, and a 135° polarization channel that captures intensity measurements of polarized light at 135° polarization angle.

The pFLF imaging system 100 also includes one or more computing devices 194 having one or more processors or other circuitry 194, an optional (denoted by dashed line) display 197 in electrical communication with the processor(s) or other circuitry 194, and a computer readable media (CRM) 196 in electronic communication with the processor(s) or other circuitry 194. The CRM 196 may be, e.g., a non-transitory computer readable media. The computing device(s) 194 may include, for example, a personal computer, an embedded computer, a single board computer (e.g. Raspberry Pi or similar), a portable computation device (e.g. tablet), a controller, or any other computation device or system of devices capable of performing the functions described herein. The computing device(s) 194 may be in electronic communication with the polarization camera 170 to send control signals to control image acquisition and to receive image data. The processor(s) and/or other circuitry 195 are in electrical communication with the CRM 196 to store and/or retrieve image data. The processor(s) and/or other circuitry 195 are in electrical communication with the optional display 197 for displaying data including images. Although not shown, the computing device(s) 194 may also include a user input component for receiving data from a user.

The one or more processors and/or other circuitry 195 and/or one or more external processors may execute instructions stored on the CRM 196 to perform one or more operations of the pFLF imaging system 100. For example, processor(s) and/or other circuitry 195 and/or one or more external processors may execute instructions to perform one or more of: 1) communicating control signals to one or more components of the pFLF imaging system 100 to perform operations of the pFLF imaging system 100 and 2) perform one or more operations of a pFLF imaging method such as reconstruction operations to reconstruct one or more volumetric fluorescence images of the sample 101. For example, the processor(s) and/or other circuitry 195 and/or one or more external processors may execute instructions that communicate control signals to the polarization camera 170 to perform single shot image acquisition of at least one raw image and record the image data. As another example, the processor(s) and/or other circuitry 195 and/or one or more external processors may execute instructions that communicate control signals to the light sources(s) 110 to trigger emission of excitation light. In yet another example, the processor(s) and/or other circuitry 195 and/or one or more external processors may execute instructions that communicate control signals to an adjustable iris to set the field-of-view of the images.

The electrical communication between components of the pFLF imaging system 100 may be in wired and/or wireless form. One or more of the electrical communications between components of the pFLF imaging system 100 may be able to provide power in addition to communicate signals. In some cases, the pFLF imaging system 100 may include one or more communication interfaces (e.g., a universal serial bus (USB) interface). Communication interfaces can be used, for example, to connect various peripherals and input/output (I/O) devices such as a wired keyboard or mouse or to connect a dongle for use in wirelessly connecting various wireless-enabled peripherals. Such additional interfaces also can include serial interfaces such as, for example, an interface to connect to a ribbon cable. It should also be appreciated that the various system components can be electrically coupled to communicate with various components over one or more of a variety of suitable interfaces and cables such as, for example, USB interfaces and cables, ribbon cables, Ethernet cables, among other suitable interfaces and cables.

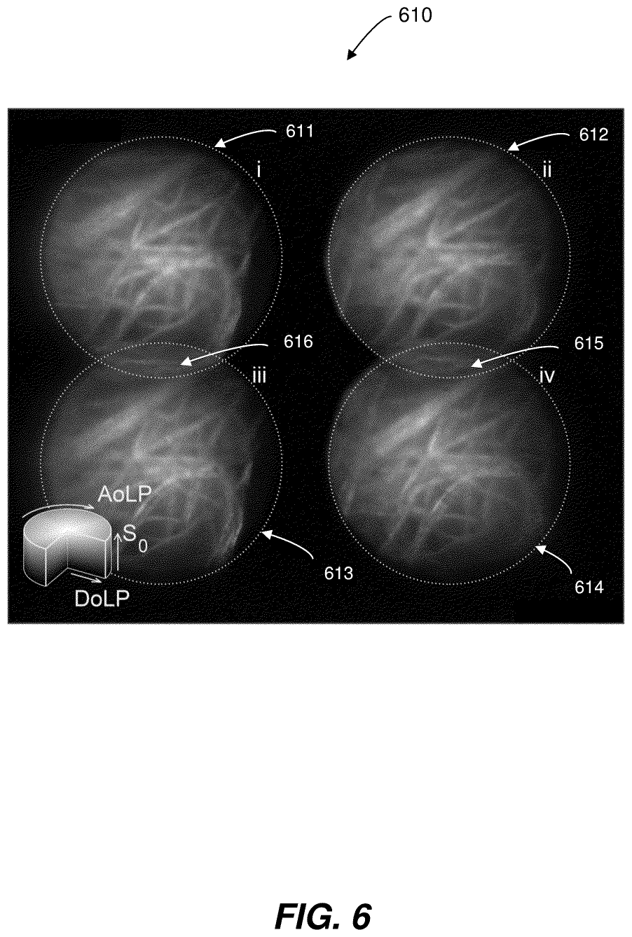

The pFLF imaging system 100 is operable to perform single shot acquisition of five-dimensional (5D) data including 3D fluorescence intensity data (x,y,z) and 2D polarization data. At each single shot data acquisition, polarized excitation illumination is delivered to the sample 101 which can activate one or more types of fluorophores in the sample 101 emitting fluorescence emissions. The second optical system 160 projects an image of the sample 101 from the microlens array 150 onto the polarization camera 170. The second optical system 160 includes one or more optical elements (e.g., optical elements in 4f configuration) that can transform the light field from the image at the intermediate image plane to the Fourier domain. The lenslets of the microlens array 150 segment the wavefront at the pupil plane transmitting spatial frequencies with angular information to different regions of the polarization camera 170. The polarization camera 170 acquires a raw image using the plurality of polarization channels corresponding to respective polarizations of its polarized pixels and outputs a raw image to the computing device 194. The raw image includes a plurality of polarized sub-images corresponding to the respective polarizations. For example, the polarization camera 170 may output a raw image using four polarization channels where the raw image includes four polarized two-dimensional (2D) sub-images (e.g., polarized sub-images 611, 612, 613, and 614 in FIG. 6) corresponding to a 0° polarization angle, a 45° polarization angle, a 90° polarization angle, and a 135° polarization angle. By applying a 2D-to-3D reconstruction procedure, a 3D volumetric dataset can be generated from each polarized sub-image along with the point spread function. A voxel-wise combination of the 3D volumetric intensity datasets based on the Stokes relationships defined in Eqns. 1A-1C, 2, and 3 can be applied to generate a volumetric fluorescence volumetric fluorescence image with 3D fluorescence intensity data and 2D polarization data (e.g., AoLP and DoLP data).

According to various embodiments, a pFLF imaging system includes one or more light sources (e.g., laser sources) operable to generate excitation light that can activate one or more types of fluorophores in a sample being imaged. Various wavelengths can be implemented. Some examples of suitable ranges of wavelengths include near-ultraviolet (320-400 nm), blue (450-490 nm), green (500-550 nm), yellow/orange (550-600 nm), and near infrared (700 nm and greater). In some cases, a pFLF imaging system may include at least one laser source for providing excitation light. An example of a suitable laser source is a 488-nm laser such as the LP488-SF20G visible laser diode manufactured by Thorlabs.

In various embodiments, a pFLF imaging system includes one or more optical systems. In some cases, a pFLF imaging system includes a first optical system with one or more optical elements configured to create polarized excitation illumination from the excitation light illumination provided by a light source(s), deliver the polarized excitation illumination to a sample being imaged, and propagate fluorescence emissions from the sample being imaged to lenslets of a microlens array. For example, the first optical system may include a quarter waveplate, a linear polarizer, and a half waveplate to create polarized excitation illumination from the excitation illumination provided by the light source(s). As another example, the first optical system may include a linear polarizer, an electro-optic modulator, and a quarter waveplate to create polarized excitation illumination from the excitation illumination provided by the light source(s). The first optical system may include a microlens array. The microlens array can segment the wavefront to transmit corresponding spatial frequencies corresponding to different microlenses to form images in different regions of the polarization camera. In reconstruction, different spatial frequency information may be treated as complementary microlens-specific measurements; an inverse algorithm uses these calibrated PSFs to jointly fit all spatial frequencies and recover a single fused 3D volume. In some cases, a pFLF imaging system includes a second optical system with one or more optical elements configured to project an image of the sample from a microlens array onto the polarization camera. In certain aspects, the second optical system includes optical elements in a 4f configuration (4f optical system) that can transform the light field from the image at the intermediate image plane to the Fourier domain. For example, the pFLF system 200 in FIG. 2 has a second optical system with a 4f optical system including a third lens 262 (e.g., f=30 mm) and a fourth lens 264 (e.g., f=80 mm).

In various embodiments, pFLF imaging systems include a polarization camera (e.g., DZK 33UX250 polarization camera manufactured by The Imaging Source) that can capture multi-dimensional image data (intensity and polarization data) in a single shot. As used herein, a “single shot” or “single data acquisition” generally refers to a data acquisition procedure during which the polarization camera captures intensities at a sensing surface during a single exposure time. The polarization camera may include an array of polarized pixels for acquiring intensity measurements of polarized light at different polarization angles (sometimes referred to herein as “polarization orientations” or “polarizations”). The polarization angles are measured with reference to a local x-axis (e.g., x-axis shown in FIG. 4) at a plane at the sensing surface of the polarization camera. The array may be a two-dimensional or one-dimensional array. For example, the polarization camera may include a rectangular two-dimensional array (N×M dimensions) of polarized pixels for taking intensity measurements associated with four polarization angles (e.g., polarization angles of 0°, 45°, 90°, and 135°, polarization angles of 0°, 22.5°, 45°, 67.5°, and 90°, etc.). The array may have any suitable dimensions such as 2×2, 4×4, and 8×8. In one embodiment, the polarization camera may also include one or more unfiltered pixels for capturing the total intensity.

In embodiments where the polarization camera includes an array of polarized pixels, each polarized pixel may include a micro-lens, a polarization filter corresponding to a polarization angle (e.g., nanowires oriented in the direction of the polarization axis or angle), and a sensor element. In some cases, the sensor element may be one of a photodiode, complementary metal oxide semiconductor (CMOS) sensor, or a charge-coupled device (CCD). For example, each polarized pixel may include a micro-lens, a polarization filter corresponding to a polarization angle, and a CMOS sensor. In other cases, the sensor element may include an event camera. Using event cameras can advantageously enable ultrafast imaging.

In various embodiments, the polarization camera includes a plurality of polarization channels that capture intensity data of polarized light at different polarization angles. Each polarization channel corresponds to intensities captured at polarized pixels associated with one polarization angle. With reference to FIG. 4, for example, a first polarization channel associated with polarization angle 0° (0° polarization channel) includes intensities captured at polarized pixels 273, 275, 281, and 283, a second polarization channel associated with polarization angle 45° (45° polarization channel) includes intensities captured at polarized pixels 277, 279, 285, and 287, a third polarization channel associated with polarization angle 90° (90° polarization channel) includes intensities captured at polarized pixels 276, 278, 284, and 286, and a fourth polarization channel associated with polarization angle 135° (135° polarization channel) includes intensities captured at polarized pixels 272, 274, 280, and 282. In one embodiment, the polarization camera may also use an unfiltered intensity channel for capturing an intensity image based on the total intensity of light captured by one or more unfiltered pixels in the array. During operation, the polarization camera outputs each raw image using the plurality of polarization channels. Each channel includes polarized pixel intensities at one polarization angle. For example, the polarization camera 270 in FIG. 2 can be used to output the raw image 610 in FIG. 6 using the first polarization channel (0° polarization channel), the second polarization channel (45° polarization channel), the third polarization channel (90° polarization channel), and the fourth polarization channel (135° polarization channel).

In some cases, the polarized pixels of the polarization camera may be arranged in blocks of polarized pixels (pixel blocks). Each pixel block includes at least one polarized pixel that can measure intensities at one of the polarization angles being measured by the polarization camera. For example, the polarization camera may include a two-dimensional (rectangular) 4×4 array (N=4 and M=4) of sixteen (16) polarized pixels divided into four four-pixel blocks. Each block includes four polarized pixels for measuring intensities along the four polarization angles such as polarization angles 0°, 45°, 90°, and 135° or other suitable polarization angles. For example, each four four-pixel block may include a polarized pixel for measuring intensities at polarization angle 0°, a polarized pixel for measuring intensities at polarization angle 45°, a polarized pixel for measuring intensities at polarization angle 90°, and a polarized pixel for measuring intensities at polarization angle 135°.

The three Stokes parameters can be determined from measured pixel intensities of the polarized pixels having different polarizations using the relationships defined in Eqns. 1A-1C. For example, the intensity measurements of a first polarized pixel for measuring intensities at polarization angle 0° (P_{0°}) and third polarized pixel for measuring intensities at polarization angle 90° (P_{90°}) can be used to determine the first Stokes parameter, S₀, using Eqn. 1A and the second Stokes parameter, S₁, using Eqn. 1B and the intensity measurements of a fourth polarized pixel for measuring intensities at polarization angle 135° (P_{135°}) and a second polarized pixel for measuring intensities at polarization angle 45° (P_{45°}) can be used to determine the third Stokes parameter, S₂, using Eqn. 1C. Using Eqns. 2 and 3, the AoLP and the DoLP can be determined based on the determined S₁ and S₂.

At each single-shot acquisition, the polarization camera records a raw image consisting of a plurality of polarized sub-images. The field-of-view of each of the polarized sub-images may be set by an iris positioned at the intermediate image plane of the pFLF imaging system. For example, the field-of-view of the four polarized sub-images 611, 612, 613, and 614 shown in FIG. 6 is set by the iris 246 at intermediate image plane 257 of the pFLF imaging system 200 shown in FIG. 2. In this implementation, the polarized sub-images 611, 612, 613, and 614 have overlapping portions (overlaps) 615, 616. In other implementations, the polarized sub-images do not have overlapping portions.

In various embodiments, a pFLF imaging system includes a microlens array (MLA) of lenslets (sometimes referred to herein as “microlenses”) positioned at the pupil plane. (e.g., pupil plane 251 in FIG. 2). In many examples, the MLA is a two-dimensional array. For example, the MLA may be a rectangular array having dimensions of 2×2, 4×4, or 6×6. In some cases, the MLA may be a one-dimensional linear or curved array. Various array dimensions may be used. In one example, the MLA may be a hexagonal microlens array such as a 7 lenslet or 19 lenslet hexagonal arrangement. An example of a 7 lenslet hexagonal microlens array is the ML-H123-F5 microlens array sold by Zokoptics.

Various pitch (e.g., 100 μm, 500 μm, 1 mm, 2 mm, etc.) and focal lengths (e.g., 5 mm, 10 mm, 35 mm, 75 mm, etc.) of lenslets may be used. In some cases, all the lenslets of the MLA have the same focal length. In one embodiment, the MLA may include lenslets with varying focal lengths which can advantageously extend the depth of field, as the lenslets are optimally focused for different axial planes. For this embodiment, reconstruction is generally the same inverse-problem approach as used with the implementation having lenslets with the same focal lengths, except the forward model uses lenslet-specific (and potentially asymmetric/non-identical) PSFs corresponding to the different focal lengths.

In various embodiments, a pFLF imaging system includes an iris (e.g., iris 246 in FIG. 2) located at an intermediate image plane that sets the field-of-view of the raw image and polarized sub-images. The iris may be adjustable or may be fixed. In some implementations, the iris can be used to set the field-of-view at the intermediate image plane to separate the light field signals on the polarization camera sensor plane to reduce or avoid overlapping of the polarized sub-images. The iris sets the pupil at the pupil plane to align with a set of lenslets of the MLA. For example, an iris located at the intermediate image plane of the pFLF imaging system may set the pupil at the pupil plane to align with a set of lenslets (e.g., a set of four lenslets) in the microlens array.

FIG. 2 is a schematic drawing of components of a pFLF imaging system 200, according to embodiments. The pFLF imaging system 200 is an example of Fourier light field imaging microscopy. For the sake of brevity, the prior discussion of similar or analogous elements with regards to FIG. 1 may be assumed to be equally applicable, unless indicated otherwise in the following discussion, to the similar or analogous counterparts of those elements in FIG. 2 that share the same last two digits in their respective callouts as in FIG. 1. FIG. 1 includes an enlarged portion of an inset C.

The pFLF imaging system 200 includes one or more light sources 210 operable to emit excitation light of a range of wavelengths for activating fluorophores in a sample 101 being imaged. The activated fluorophores in the sample 201 emit fluorescence emissions. The one or more light sources 210 may include a laser source. An example of a suitable laser source is a 488-nm laser such as the LP488-SF20G visible laser diode manufactured by Thorlabs.

The pFLF imaging system 200 also includes a first optical system in optical communication with the light source(s) 210. The first optical system includes one or more optical fibers (e.g., a single-mode fiber) 222, a first lens 224 (L1), a quarter-wave plate 225 (QWP), a collector lens 226 (e.g. Kohler lens), a beam splitter 228 (e.g., a dichroic mirror), an objective lens 230, a bandpass filter 242, a tube lens 244, an adjustable iris 246 at an intermediate image plane 257, a second lens 248, and a microlens array 250 at a pupil plane 251. An example of a suitable beam splitter 228 is a dichroic mirror such as the Dual-Edge laser Dichroic Beamsplitter Di01 R488/561 sold by Semrock. The beam splitter 228 can reflect wavelength of the polarized excitation illumination and pass wavelength of the fluorescence emissions. An example of a suitable objective lens 230 that can be used is a 20×, 0.4-NA objective lens such as the objective lens PLN20X sold by Olympus. Various tube lenses may be used. An example of a suitable tube lens has a focal length of 150 mm. An example of a suitable microlens array 250 is the MLAIM microlens array manufactured by Thorlabs.

The pFLF imaging system 200 also includes a second optical system with a third lens 262 (L3) and a fourth lens 264 (L4) in a 4f optical configuration, a polarization camera 270, and a computing device 294. In one case, the second optical system includes a third lens 262 (L3) with a focal length, f₃, of 30 mm and a fourth lens 264 (L4) with a focal length, f₄, of 80 mm for a 4f optical configuration. The computing device 294 is in electronic communication with the polarization camera 270 to send control signals and receive data with one or more raw images. In another implementation, the computing device 294 may also be in electronic communication with the light source(s) 210 to send control signals. An example of a polarization camera 270 that can be employed is the DZK 33UX250 polarization camera sold by The Imaging Source DZK. In other implementations, other combinations of optical elements may be used in the first optical system and/or the second optical system.

The light source(s) 210 coupled to the one or more optical fibers 222 is modulated by the first lens 224, the quarter-wave plate 225, and the collector lens 226 to create circularly polarized excitation illumination. In an alternative implementation, a linear polarizer and an electro-optic modulator can be added before the quarter-wave plate 225 to create linearly polarized excitation with controlled orientation. After reflection from the beam splitter 228 and passing through the objective lens 230, the resulting polarized excitation illumination at the sample 201 may be generally uniform and circularly polarized. The objective lens 230 and the tube lens 244 are used to create the intermediate image plane 257. The iris 257 located at the intermediate image plane 257 can be used to adjust the field-of-view. The fluorescence emissions captured by the objective lens 230 and passing through the beam splitter 228 are filtered using the bandpass filter 242. An example of a suitable bandpass filter is the bandpass filter FF01-523/610 manufactured by Semrock. The second lens 248 (e.g., lens with focal length, f₂ of 40 mm) projects the pupil plane onto the microlens array 250, where the pupil 261 is demagnified to align with a set of four lenslets 252, 253, 254, and 255 of the MLA 250. The 4f optical configuration of the third lens 262 (L3) and a fourth lens 264 (L4) can magnify and project the images from the MLA 250 onto the polarization camera 270.

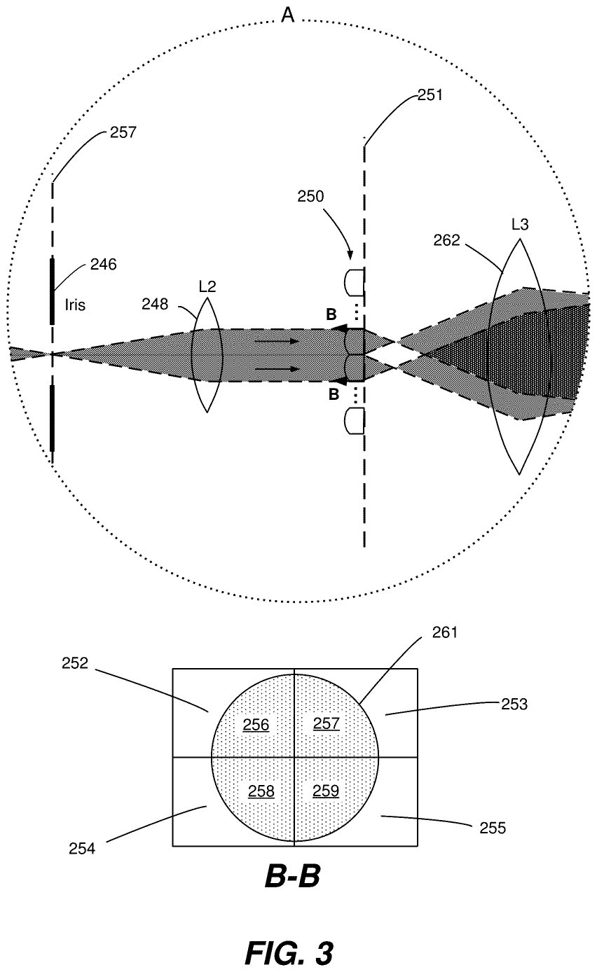

FIG. 3 is a schematic drawing of components of the pFLF imaging system 200 in FIG. 2. The schematic illustration includes an enlarged portion of the inset A in FIG. 2 at a x-z plane through the center of the MLA 250. The schematic illustration also includes a drawing of a cross-sectional view B-B of the MLA 250. The MLA 250 is a two-dimensional array of lenslets having dimensions N×M (e.g., 2×2, 4×4, or 6×6). The lenslets of the MLA 250 have the same focal length (e.g., 5 mm, 10 mm, 35 mm, 75 mm. In other implementations, the MLA 250 includes lenslets with varying focal lengths which can advantageously extend the depth of field.

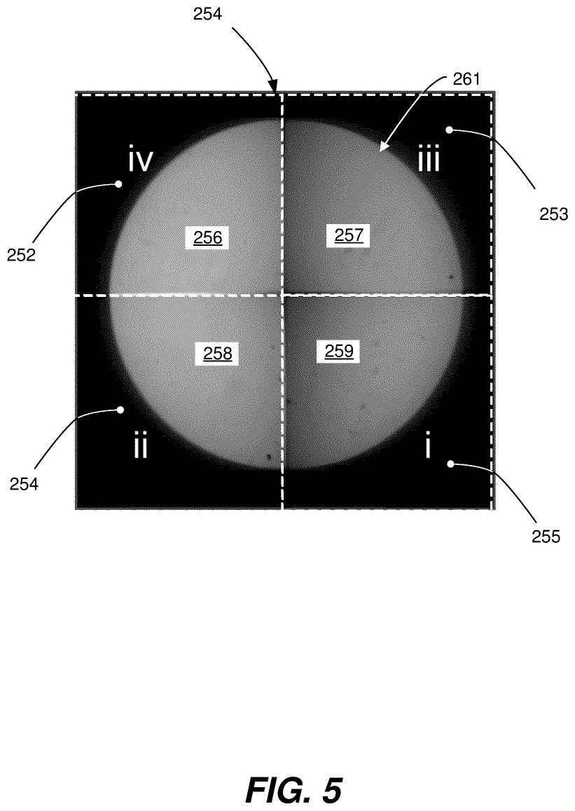

In various implementations, the iris 257 may be used to adjust the diameter of the pupil 261 to align the pupil 261 with a set of lenslets of the MLA 250. For example, in the illustrated implementation, the iris 246 is set to generate a pupil 261 at the pupil plane 251 that aligns with a set of four lenslets 252, 253, 254, and 255. The cross-sectional view B-B in FIG. 3 illustrates the alignment of the pupil 261 relative to the four lenslets 252, 253, 254, and 255. The pupil 261 has four sections 256, 257, 258, and 259. FIG. 5 is an image of the set of four lenslets 252, 253, 254, and 255 of the MLA 250 of the pFLF imaging system 200 shown in, and described with respect to, FIG. 2. As shown, the pupil 261 aligns with the four lenslets 252, 253, 254, and 255.

FIG. 4 is a schematic drawing of a plan view of a polarization sensor 271 of the polarization camera 270 in FIG. 2, according to various implementations. The polarization sensor 271 includes a 4×4 two-dimensional rectangular array of sixteen (16) polarized pixels 272, 273, 274, 275, 276, 277, 278, 279, 280, 281, 282, 283, 284, 285, 286, and 287. In other implementations, other dimensions may be used. The illustration includes a local x-axis and γ-axis at the sensing surface of the polarization camera 270. The polarization angles are measured relative to the local x-axis. The polarized pixels 272, 273, 274, 275, 276, 277, 278, 279, 280, 281, 282, 283, 284, 285, 286, and 287 are arranged in four-pixel blocks 288, 289, 290, and 291. Each block includes four polarized pixels for measuring intensities along four polarization angles 0°, 45°, 90°, and 135°. For example, the four four-pixel block 288 includes a polarized pixel 273 for measuring intensities at polarization angle 0°, a polarized pixel 277 for measuring intensities at polarization angle 45°, a polarized pixel 276 for measuring intensities at polarization angle 90°, and a polarized pixel 272 for measuring intensities at polarization angle 135°. In other implementations, other polarization angles may be used.

For each pixel block, the three Stokes parameters can be determined from measured intensities of the polarized pixels having different polarizations using the relationships defined in Eqns. 1A-1C. For example, the intensity measurements of polarized pixel 273 (P_{0°}) and polarized pixel 276 (P_{90°}) can be used to determine the first Stokes parameter, S₀, for block 288 using Eqn. 1A and the second Stokes parameter, S₁, using Eqn. 1B and the intensity measurements of polarized pixel 272 (P_{135°}) and polarized pixel 277 (P_{45°}) can be used to determine the third Stokes parameter, S₂, for block 288 using Eqn. 1C. For each pixel block, the AoLP and the DoLP can be determined using Eqns. 2 and 3.

The polarization camera 270 includes four polarization channels that capture intensity data of polarized light at the four polarization angles 0°, 45°, 90°, and 135°. A first polarization channel associated with polarization angle 0° (0° polarization channel) includes intensities captured at polarized pixels 273, 275, 281, and 283, a second polarization channel associated with polarization angle 45° (45° polarization channel) includes intensities captured at polarized pixels 277, 279, 285, and 287, a third polarization channel associated with polarization angle 90° (90° polarization channel) includes intensities captured at polarized pixels 276, 278, 284, and 286, and a fourth polarization channel associated with polarization angle 135° (135° polarization channel) includes intensities captured at polarized pixels 272, 274, 280, and 282. In one embodiment, the polarization camera 270 may also include an unfiltered intensity channel for capturing an intensity image based on the total intensity of light captured by one or more unfiltered pixels in the array. During operation, the polarization camera 270 outputs each raw image using a (i) first polarization channel (0° polarization channel), a (ii) second polarization channel (45° polarization channel), a third (iii) polarization channel (90° polarization channel), and a fourth (iv) polarization channel (135° polarization channel).

FIG. 6 is an example of a raw image 610 of a wheat root captured by an implementation of the pFLF imaging system 200 shown in FIG. 2, according to an embodiment. The raw image 610 includes four polarized sub-images 611, 612, 613, and 614 corresponding to pixel intensities along polarization axes 0°, 45°, 90°, and 135°. In the illustrated example, the polarized sub-images 611, 612, 613, and 614 have overlapping portions (overlaps) 615, 616. In other implementations, the polarized sub-images do not have overlapping portions. The raw image 610 was output using polarization channels (i)-(iv) corresponding to the polarization axes 0°, 45°, 90°, and 135°. The field-of-view of the polarized sub-images 611, 612, 613, and 614 in polarization channels (i)-(iv) is set by the iris 246. In some cases, the iris 246 can be used to set the field-of-view at the intermediate image plane 257 to separate the light field signals on the sensor plane of the polarization camera 270 to change the field-of-view to reduce or eliminate the overlapping portions (overlaps) 615, 616. Reducing overlap decreases cross-talk between sub-images, making reconstruction more robust and requiring less sparsity/regularization, but it trades off a smaller field-of-view.

The polarized sub-images 611, 612, 613, and 614 corresponding to the polarization channels can be used to determine the three Stokes parameters, S₀, S₁, and S₂. The Stokes parameters, S₀, S₁, and S₂ can be further mapped to intensity (equal to S₀), the angle of linear polarization (AoLP) using Eqn. 2, and the degree of linear polarization using Eqn. 3. To visualize these parameters simultaneously, a polarization colormap can be applied to combine the angle of linear polarization (AoLP), the degree of linear polarization (DoLP), and the intensity (S₀) in HSV (hue, saturation, value) colorspace where color represents the AoLP, saturation represents the DoLP, and brightness represents the intensity. An example of a polarization colormap can be found in Bruggeman, E., Zhang, O., Needham, L M. et al. POLCAM: instant molecular orientation microscopy for the life sciences. Nat Methods 21, 1873-1883 (2024). Specifically, white denotes isotropic polarization, a highly saturated color indicates strong linear polarization along a specific direction, and black represents low intensity. This polarization colormap may also be applied for visualizing reconstruction results. The polarized sub-images 611, 612, 613, and 614 shown in FIG. 6 have been color-coded by the polarization colormap according to the angle of linear polarization (AoLP), degree of linear polarization (DoLP), and Stokes parameter S₀ (intensity). In some cases, the polarization colormap may also be applied for visualizing reconstruction results.

During image reconstruction, a 3D volumetric dataset may be generated from each polarized 2D sub-image along with the PSFs (point spread functions) using a 2D-to-3D reconstruction procedure such as a Richardson-Lucy (RL) deconvolution procedure, a sparsity-regularized RL deconvolution procedure, a neural fields representation procedure, etc. A voxel-wise combination of the 3D volumetric intensity datasets based on Stokes relationships defined in Eqns. 1A-C, 2, and 3 below can be applied to generate a volumetric fluorescence image with 3D fluorescence intensity data and 2D polarization data such as AoLP and DoLP data.

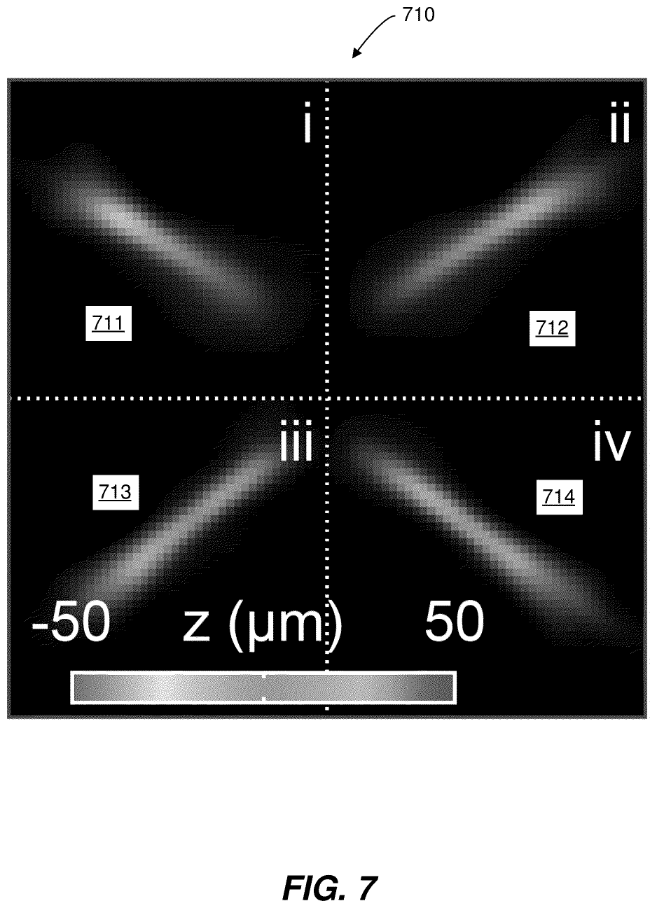

In various embodiments, the PSFs used in reconstruction may be experimentally determined for a pFLF imaging system. For example, experimental PSFs can be obtained by scanning fluorescent beads across a range from −50 to +50 μm. In other cases, the PSFs may be theoretically determined using a theoretical forward model of the optical system (e.g., wave-optics/Fourier optics modeling of the pupil function including the objective, MLA subapertures, and polarization analyzer), to compute microlens- and polarization-channel-specific 3D PSFs. FIG. 7 is an illustration of an example of point spread functions (PSFs) experimentally determined for the pFLF imaging system 200 in FIG. 2, according to an embodiment. The PSFs are color-coded with depth z in polarization channels (i)-(iv), which correspond to four sections 256, 257, 258, and 259 of the pupil 261 in FIG. 6. In this example, the PSFs were obtained by scanning fluorescent beads across a range from −50 to +50 μm. In the z-dependent PSFs, focal spots in each polarization channel exhibit lateral shifts in different directions corresponding to the lenslets' positions on the pupil.

The computing device(s) 294 may include one or more processors or other circuitry, an optional display in electrical communication with the processor(s) or other circuitry, and a computer readable media (CRM) in electronic communication with the processor(s) or other circuitry. The CRM may be, e.g., a non-transitory computer readable media. The computing device(s) 294 may include, for example, a personal computer, an embedded computer, a single board computer (e.g., Raspberry Pi or similar), a portable computation device (e.g. tablet), a controller, or any other computation device or system of devices capable of performing the functions described herein. The computing device(s) 294 may be in electronic communication with the polarization camera 270 to send control signals to control image acquisition and to receive image data. The processor(s) and/or other circuitry are in electrical communication with the CRM to store and/or retrieve image data. The processor(s) and/or other circuitry are in electrical communication with the optional display for displaying data including images.

The one or more processors and/or other circuitry 195 and/or one or more external processors may execute instructions stored on the CRM to perform one or more operations of the pFLF imaging system 200. For example, processor(s) and/or other circuitry and/or one or more external processors may execute instructions to perform one or more of: 1) communicating control signals to one or more components of the pFLF imaging system 200 to perform operations of the pFLF imaging system 200 and 2) perform one or more operations of a pFLF imaging method such as reconstruction operations to reconstruct one or more volumetric fluorescence images of the sample 201. For example, the processor(s) and/or other circuitry and/or one or more external processors may execute instructions that communicate control signals to the polarization camera 270 to perform single shot image acquisition of at least one raw image and record the image data. As another example, the processor(s) and/or other circuitry and/or one or more external processors may execute instructions that communicate control signals to the light sources(s) 210 to trigger emission of excitation light. In yet another example, the processor(s) and/or other circuitry and/or one or more external processors may execute instructions that communicate control signals to an adjustable iris to set the field-of-view of the images.

The electrical communication between components of the pFLF imaging system 200 may be in wired and/or wireless form. One or more of the electrical communications between components of the pFLF imaging system 200 may be able to provide power in addition to communicate signals. In some cases, the pFLF imaging system 200 may include one or more communication interfaces (e.g., a universal serial bus (USB) interface).

In one embodiment, a pFLF imaging system includes a custom-designed metasurface or phase plate at the pupil plane instead of a microlens array. Implementing a custom-designed metasurface or phase plate can enhance resolution and polarization sensitivity. In one case, the metasurface or phase plate can be designed with a custom polarization and phase pattern optimized for 5D imaging. Examples of the custom-designed metasurface or phase plate include a geometric-phase metasurface with spatially varying nanoelement orientations that imparts polarization-dependent phase, a birefringent phase plate that applies different phase profiles to orthogonal linear polarization states, and an engineered-PSF phase plate (e.g., double-helix or tetrapod) to encode axial position, optimized for sensitivity to 5D parameters while maintaining photon efficiency and fabrication feasibility. The custom-designed metasurface or phase plate may be paired with the polarization sensor of the polarization camera to improve the image quality.

In one embodiment, a pFLF imaging system may implement sophisticated vectorial emission models to compensate for a polarization mixture caused by the z-oriented component of the fluorophore's orientation. Examples of vectorial emission models can be found in D. Axelrod, “Fluorescence excitation and imaging of single molecules near dielectric-coated and bare surfaces: a theoretical study,” Journal of Microscopy 247(2), 147-160 (2012) and A. S. Backer and W. E. Moerner, “Extending Single-Molecule Microscopy Using Optical Fourier Processing,” The Journal of Physical Chemistry B 118 (28), 8313-8329 (2014). In one case, the pFLF imaging system may use a high numerical aperture (NA) objective for improved resolution, which may have particular utility for applications requiring finer resolution such as imaging subcellular structures including actin filaments, microtubules, and cellular membranes. However, the polarization mixture caused by the z-oriented component of the fluorophore's orientation could become significant when employing a high NA objective lens. In this case, the pFLF imaging system may compensate for polarization mixture effects using more sophisticated vectorial emission models.

In some embodiments, the polarization camera includes a monochromatic polarization sensor. For example, the polarization camera 270 in FIG. 2 includes a monochromatic polarization sensor. In other embodiments, the polarization camera may include a multi-spectral polarization sensor. By implementing a multi-spectral polarization sensor, the pFLF imaging system can simultaneously capture spectral and polarization information, enabling six-dimensional (6D) imaging.

### III. Polarized Fourier Light Field Microscopy Imaging Methods

Generally speaking, for each single-shot acquisition, the polarization camera captures a raw image. The polarization camera outputs the raw image into a plurality of polarization channels including a plurality of polarized sub-images. The polarized sub-images correspond to polarized pixel intensities detected along corresponding polarization axes. Each polarization channel corresponds to polarized pixel intensities along one of the polarization axes. For example, the polarization camera 270 in FIG. 2 can be used to output a raw image 610 split into a first polarization channel, a second polarization channel, a third polarization channel, and a fourth polarization channel corresponding to the four polarized sub-images 611, 612, 613, and 614 shown in FIG. 6. In one case, the four polarized sub-images 611, 612, 613, and 614 may correspond to polarized pixel intensities along respective 0°, 45°, 90°, and 135° polarization axes. The polarization camera may use a plurality of polarization channels for capturing light polarized at the corresponding polarization axes of the polarized pixels. The angle and degree of polarization may be determined by comparing the intensities captured at the different polarized pixels. To reconstruct the 3D volumetric intensities along with the AoLP and DoLP, raw images may be segmented into a 0° polarized sub-image, a 45° polarized sub-image, a 90° polarized sub-image, and a 135° polarized sub-image. These polarized sub-images, along with the PSF, may be processed using a 2D-to-3D reconstruction procedure to reconstruct 3D volumetric datasets for each of the four polarizations. These 3D volumetric datasets may then be combined to produce the volumetric AoLP, DoLP, and intensity.

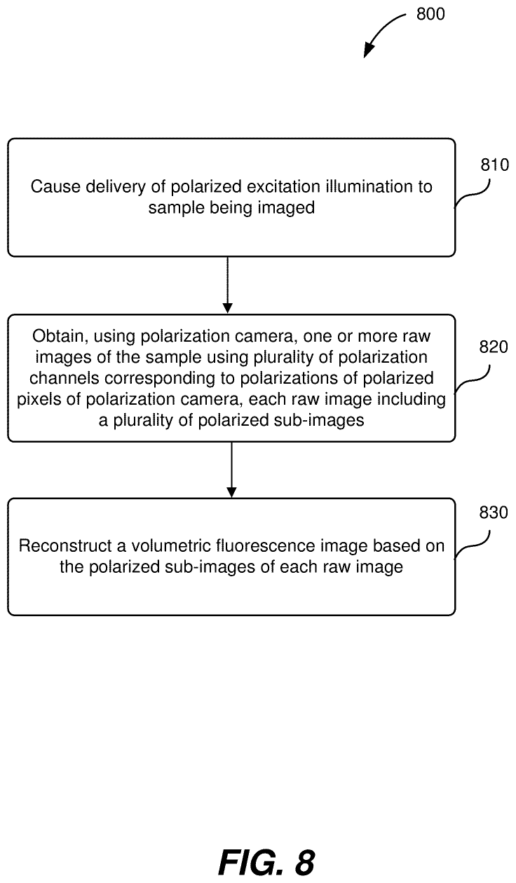

FIG. 8 is a flowchart depicting an example polarized Fourier light field (pFLF) imaging method 800, according to various embodiments. Blocks of pFLF imaging method 800 may be executed by one or more processors of one or more computing devices (e.g., computing device(s) 194). In some implementations, blocks of the pFLF imaging method 800 may be executed in an order other than what is shown in FIG. 8. In some embodiments, one or more blocks of pFLF imaging method 800 may be omitted, and/or two or more blocks may be executed substantially in parallel. For example, in some cases, block 810 may be omitted. This pFLF imaging method 800 may be implemented by pFLF imaging systems of various embodiments. For example, the pFLF imaging method 800 may be implemented by the pFLF imaging system 100 shown in FIG. 1 or the pFLF imaging system 200 shown in FIG. 2.

The pFLF imaging method 800 can begin at block 810 by causing delivery of polarized excitation illumination to a sample being imaged. For example, the pFLF imaging method 800 may cause, using one or more light sources, an excitation light to be emitted. One or more optical elements may convert the excitation light into polarized excitation illumination and deliver the polarized excitation illumination to the sample. For example, a quarter-wave plate may be implemented to create polarized illumination from the excitation light. In an alternative implementation, a linear polarizer and an electro-optic modulator can be added before the quarter-wave plate 225 to create linearly polarized excitation with controlled orientation. The one or more light sources may include one or more lasers, one or more LEDs, etc. In some implementations, two light sources of different types (e.g., a laser and an LED), each of which may emit light in a different wavelength region may be used. Note that excitation light may be emitted continuously, or may be pulsed. The excitation light may be in one or more wavelength regions that can activate fluorophores in the sample. In response, the activated fluorophores emit fluorescence emissions. Lenslets of a microlens array capture fluorescence emissions issuing from the sample from different angles. Fluorescence emissions from the sample are divided by the lenslets and projected to the polarization camera. During reconstruction, the different angles correspond to different sub-aperture views of the same underlying 3D fluorescence distribution. The sub-images formed by the lenslets are treated as complementary measurements, and an inverse-problem algorithm uses a forward model to predict each sub-image from a candidate 3D volume and updates the 3D volume until the predicted sub-images match the measured sub-images across all lenslets, thereby producing a single fused 3D reconstruction.

At block 820, the pFLF imaging method 800 may obtain, using a polarization camera, one or more raw images of the sample using a plurality of polarization channels. The polarization channels correspond to respective polarizations of polarized pixels of the polarization camera. For example, the polarization camera may output each raw image using a first polarization channel associated with polarization angle 0° (0° polarization channel), a second polarization channel associated with polarization angle 45° (45° polarization channel), a third polarization channel associated with polarization angle 90° (90° polarization channel), and a first polarization channel associated with polarization angle 135° (135° polarization channel). As another example, the polarization camera may output each raw image using a first polarization channel associated with polarization angle 0° (0° polarization channel), a second polarization channel associated with polarization angle 22.5° (22.5 polarization channel), a third polarization channel associated with polarization angle 67.5° (67.5° polarization channel), and a first polarization channel associated with polarization angle 90° (90° polarization channel). Each raw image includes a plurality of two-dimensional (2D) polarized sub-images (e.g., the four polarized sub-images 611, 612, 613, and 614 shown in FIG. 6) corresponding to the plurality of polarization channels. Some examples of polarization cameras are shown in and described above in connection with FIGS. 1-4. As described above, the polarization camera may include an array of polarized pixels. Each polarized pixel may include a micro, a polarization filter corresponding to a polarization angle, and a sensor element. In some cases, the polarized pixels may be arranged in blocks of polarized pixels (pixel blocks). These pixel blocks enable co-registered acquisition of multiple polarization channels at each image location without mechanically rotating polarizers. The block structure defines the effective polarization sampling grid, for example by setting the effective spatial sampling and influencing polarization estimation sensitivity and noise performance. The pixel-block arrangement also supports demosaicing/interpolation to correct pixel-to-pixel differences and reduce artifacts and cross-talk between polarization channels.

At block 830, the pFLF imaging method 800 may reconstruct a volumetric fluorescence image of the sample based on data from the polarized sub-images of each raw image captured by the polarization camera. For example, a 3D volumetric dataset may be generated from each of the polarized 2D sub-images along with the point spread function using a 2D-to-3D reconstruction procedure such as a Richardson-Lucy (RL) deconvolution procedure, a sparsity-regularized RL deconvolution procedure, a neural fields representation procedure, etc. Each 3D volumetric dataset may be generated from pixel intensities corresponding to one of the polarization channels. A voxel-wise combination of the 3D volumetric intensity datasets based on Stokes relationships defined in Eqns. 1A-C, 2, and 3 can be applied to generate a volumetric fluorescence image with 3D fluorescence intensity data and 2D polarization data such as AoLP and DoLP data.

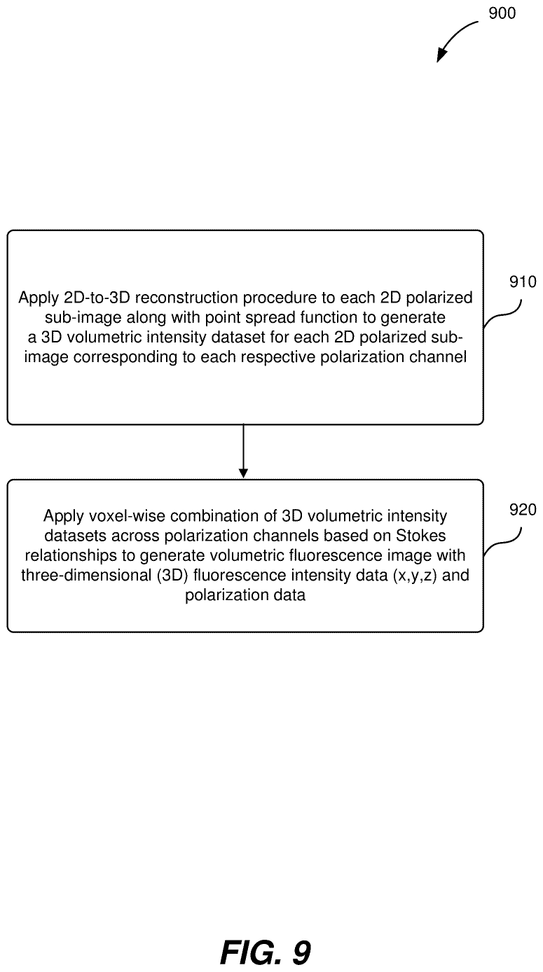

FIG. 9 is a flowchart depicting an example polarized Fourier light field (pFLF) imaging method 900, according to various embodiments. Blocks of pFLF imaging method 900 may be executed by one or more processors of one or more computing devices (e.g., computing device(s) 194). In some implementations, blocks of the pFLF imaging method 900 may be executed in an order other than what is shown in FIG. 9. In some embodiments, one or more blocks of pFLF imaging method 900 may be omitted, and/or two or more blocks may be executed substantially in parallel. This pFLF imaging method 900 may be implemented by pFLF imaging systems of various embodiments. For example, the pFLF imaging method 900 may be implemented by the pFLF imaging system 100 shown in FIG. 1 or the pFLF imaging system 200 shown in FIG. 2. According to one embodiment, the pFLF imaging method 900 includes example suboperations of block 830 in FIG. 8.

The pFLF imaging method 900 can begin at block 910 by applying a 2D-to-3D reconstruction procedure to the 2D polarized sub-images, along with the point spread function (PSF), to reconstruct respective 3D volumetric intensity datasets for the plurality of polarizations. The 2D-to-3D reconstruction procedure is applied to each 2D polarized sub-image corresponding to a polarization channel along with the point spread function to generate each 3D volumetric intensity dataset. A 3D volumetric intensity dataset is generated for each 2D polarized sub-image corresponding to a polarization channel. In the pFLF imaging system 200 in FIG. 4, for example, there are four polarization channels and four polarization resolved sub-images for each raw image acquired at each single shot acquisition. In this case, a 2D-to-3D reconstruction procedure may be applied to each of the four 2D polarized sub-images to produce four corresponding 3D volumetric intensity datasets (volumes): I₀(x,y,z), 145 (x,y,z), 190 (x,y,z), I₁₃₅ (x,y,z). For instance, the four polarized sub-images 611, 612, 613, and 614 shown in FIG. 6 can be passed through a 2D-to-3D reconstruction procedure to generate four sets of volumetric intensity data associated with 0°, 45°, 90°, and 135° polarization axes. Some examples of 2D-to-3D reconstruction procedures that can be used include a Richardson-Lucy (RL) deconvolution procedure, a sparsity-regularized RL deconvolution procedure, and a neural-fields representation procedure. Examples of deconvolution procedures can be found in Dell′Acqua, F., Rizzo, G., Scifo, P., Clarke, R. A., Scotti G., and Fazio, F., “A Model-Based Deconvolution Approach to Solve Fiber Crossing in Diffusion-Weighted MR Imaging,” in IEEE Transactions on Biomedical Engineering, vol. 54, no. 3, pp. 462-472 (March 2007) and Guo, C., Liu, W., Hua, X., Li, H., and Jia, S. “Fourier light-field microscopy,” Opt. Express 27 (18), 25573 (2019). An example of a neural-fields representation procedure can be found in Haowen Zhou, Brandon Y. Feng, Haiyun Guo, Siyu (Steven) Lin, Mingshu Liang, Christopher A. Metzler, and Changhuei Yang, “Fourier ptychographic microscopy image stack reconstruction using implicit neural representations,” Optica 10, 1679-1687 (2023). Another example can be found in Zhang, Oumeng, et al. “Single-shot volumetric fluorescence imaging with neural fields,” Advanced Photonics 7.2 (2025). In some cases, the 2D-to-3D reconstruction procedure involves forward projection and backward projection iteratively between the 3D object space and the 2D camera plane. In some cases, the PSFs being applied may be experimentally determined for the pFLF imaging system being implemented. For example, experimental PSFs can be obtained by scanning fluorescent beads across a range from −50 to +50 μm. In other cases, the PSFs may be theoretically determined using a theoretical forward model of the optical system (e.g., wave-optics/Fourier optics modeling of the pupil function including the objective, MLA subapertures, and polarization analyzer), to compute microlens- and polarization-channel-specific 3D PSFs. FIG. 7 is an illustration of an example of point spread functions (PSFs) experimentally determined for the pFLF imaging system 200 in FIG. 2.

At block 920, the pFLF imaging method 800 may apply voxel-wise combination of the 3D volumetric intensity datasets across polarization channels based on the Stokes relationships to generate a volumetric fluorescence image with three-dimensional (3D) fluorescence intensity data (x, y, z) and polarization data including AoLP and/or DoLP. The 3D fluorescence intensity data and polarization data may be computed for each voxel and then the voxel values can be combined to generate the volumetric fluorescence image. In some cases, Eqns. 1A, 1B, 1C, 2, and 3 may be used to compute AoLP and DoLP for each voxel of the 3D volumetric intensity datasets. For example, for the voxel (x0,y0,z0), Eqns. 1A, 1B, 1C, 2, and 3 can be applied to the four reconstructed intensities I₀(x0,y0,z0), I₄₅ (x0,y0,z0), I₉₀ (x0,y0,z0), and I₁₃₅ (x0,y0,z0) to obtain AoLP (x0,y0,z0) and DoLP (x0,y0,z0) values at the voxel. For example, the four 3D volumetric intensity datasets (volumes): I₀(x,y,z), I₄₅ (x,y,z), I₉₀ (x,y,z), I₁₃₅ (x,y,z) are registered to the same (x,y,z) grid, and the polarization values of the volumetric fluorescence image can be computer by combining the corresponding computed voxel values across the four polarization channels.

Generally speaking, an iris at an intermediate image plane of a PFLF imaging system can be used to set the field-of-view of the polarized sub-images. In some cases, the iris can be used to separate the light field signals on the sensor plane of the polarization camera to change the field-of-view to separate the polarized sub-images. In other cases, the raw image includes polarized sub-images with overlapping portions. For example, the four polarized sub-images 611, 612, 613, and 614 in FIG. 6 include overlapping portions 615 and 616. In these other cases, a pFLF imaging method may include a procedure for segmenting the raw image into separate polarized sub-images. For example, in one embodiment, polarized sub-images have overlaps and the pFLF imaging method 900 in FIG. 9 further includes segmenting each raw image into a plurality of 2D polarized sub-images corresponding to the plurality of polarizations. The segmenting occurs before the 2D-to-3D reconstruction procedure is applied. The segmenting procedure may include identifying a corresponding region of interest (ROI) on the polarization camera that contains the polarized sub-image, and cropping the ROIs to form separate polarized sub-images. The segmenting procedure may further include calibrating and applying per-channel registration so that the extracted polarized sub-images are aligned to a common coordinate system consistent with the PSFs used in reconstruction. In some cases, the registration can include a geometric transform (e.g., affine or higher-order warping correction) to compensate for channel-dependent distortion and aberrations before the 2D-to-3D reconstruction is performed. In addition or alternatively, the pFLF imaging method 900 in FIG. 9 may include a procedure for reducing the overlap between sub-images, which could advantageously expand the field of view and improve spatio-temporal throughput. An example of such a procedure is discussed in Q. Yang, R. Guo, G. Hu, Y. Xue, Y. Li, and L. Tian, “Wide-field, high-resolution reconstruction in computational multi-aperture miniscope using a Fourier neural network,” Optica 11 (6), 860 (2024).

In one embodiment, a pFLF imaging method may include a procedure for joint estimation of polarization data and 3D intensity data, i.e., using all polarization-channel measurements together rather than reconstructing a 3D volume per channel and combining later. For example, the method can use a single forward model that maps candidate 5D parameters (e.g., voxel-wise intensity plus polarization metrics such as AoLP/DoLP or Stokes parameters) to predicted raw measurements in each polarization channel and each microlens view, and then iteratively updates the 5D parameters to minimize mismatch between predicted and measured data across all channels. This can be more accurate because it enforces cross-channel consistency, reduces noise/cross-talk, and better handles overlap/registration errors, but it is more computationally intensive because it estimates additional unknowns and evaluates a multi-channel forward model at each iteration.

In one embodiment, a pFLF imaging method may integrate one or more machine learning techniques to potentially increase accuracy of image reconstruction of complex samples.

For example, a pFLF imaging method may implement a 2D-to-3D reconstruction procedure that integrates machine learning. In one embodiment, the pFLF imaging method 900 in FIG. 9 implements a neural representations procedure that reconstructs two-dimensional image stacks that can be used to generate the 3D volumetric datasets. An example of such a neural representations procedure is described in Haowen Zhou, Brandon Y. Feng, Haiyun Guo, Siyu (Steven) Lin, Mingshu Liang, Christopher A. Metzler, and Changhuei Yang, “Fourier ptychographic microscopy image stack reconstruction using implicit neural representations,” Optica 10, 1679-1687 (2023). This procedure can use neural representations to represent and reconstruct the 2D image stacks from the 2D polarized sub-images in each raw image acquired from the polarization camera. Another example can be found in Zhang, Oumeng, et al. “Single-shot volumetric fluorescence imaging with neural fields.” Advanced Photonics 7.2 (2025). IN this example, 2D measurements are mapped to 3D volumes using neural fields

### IV. Example Demonstrations

### Siemens Star Demonstration

To experimentally validate the pFLF imaging techniques of certain embodiments, a fluorescent Siemens star was used to demonstrate consistent resolution and an extended depth of field across various polarizations.

To demonstrate an implementation of the pFLF imaging system 200 in FIG. 2, the resolution was evaluated by a fluorescent Siemens star target with both isotropic fluorescence emission and polarized emission. In this implementation, the pFLF imaging system 200 included a light source 210 in the form of a 488-nm laser (e.g., LP488-SF20G visible laser diode manufactured by Thorlabs) coupled one or more optical fibers 222 in the form of a single mode fiber (SML), which was modulated by the first lens 224, a quarter-wave plate 225, and a collector lens 226 in the form of a Kohler lens. The beam splitter 228 was a dichroic mirror such as the Dual-Edge laser Dichroic Beamsplitter Di01 R488/561 sold by Semrock.-The objective lens 230 in the form of a 20×, 0.4-NA objective lens (objective lens PLN20X sold by Olympus) and a tube lens 244 (e.g., tube lens with focal length of 150 mm) were used to create the intermediate image plane 257. The iris 246 was positioned at the intermediate image plane 257. Captured fluorescence was filtered using a bandpass filter 242 (e.g., bandpass filter FF01-523/610 manufactured by Semrock). The second lens 248 had a focal length of 40 mm and projected the pupil plane 251 onto the microlens array 250 (e.g., MLAIM microlens array manufactured by Thorlabs), where the pupil was demagnified to align precisely with four lenslets of the MLA. A 4f optical configuration including the third lens 262 (e.g., focal length, f₃, of 30 mm) and the fourth lens 264 (e.g., focal length, f₄, of 80 mm) then magnified and projected the images from the MLA onto a polarization camera (e.g., DZK 33UX250 polarization camera sold by The Imaging Source DZK). In this example implementation, the polarization angles included 0°, 22.5°, 45°, 67.5°, and 90° polarization angles. To generate polarized fluorescence emissions, a linear polarizer was placed between the third lens 262 and the fourth lens 264 in the pFLF imaging system 200 to mimic fluorophores aligned along a specific direction. Note that although the PSF for polarized fluorescence from dipole-like emitters may differ from that of isotropic emitters such as fluorescent beads, implementing a lower NA (0.4) objective lens can significantly reduce these differences. Specifically, an isotropic emitter can be viewed as a mixture of x-, y-, and z-oriented dipole emitters. When the emitted fluorescence passes through an x-oriented linear polarizer, 95.94% of the detected intensity originates from the x-oriented dipole, while only 4.03% and 0.03% come from the z- and y-oriented components, respectively. This confirms that the use of a linear polarizer effectively mimics real fluorescence emission from dipole-like emitters with an in-(xy) plane orientation.

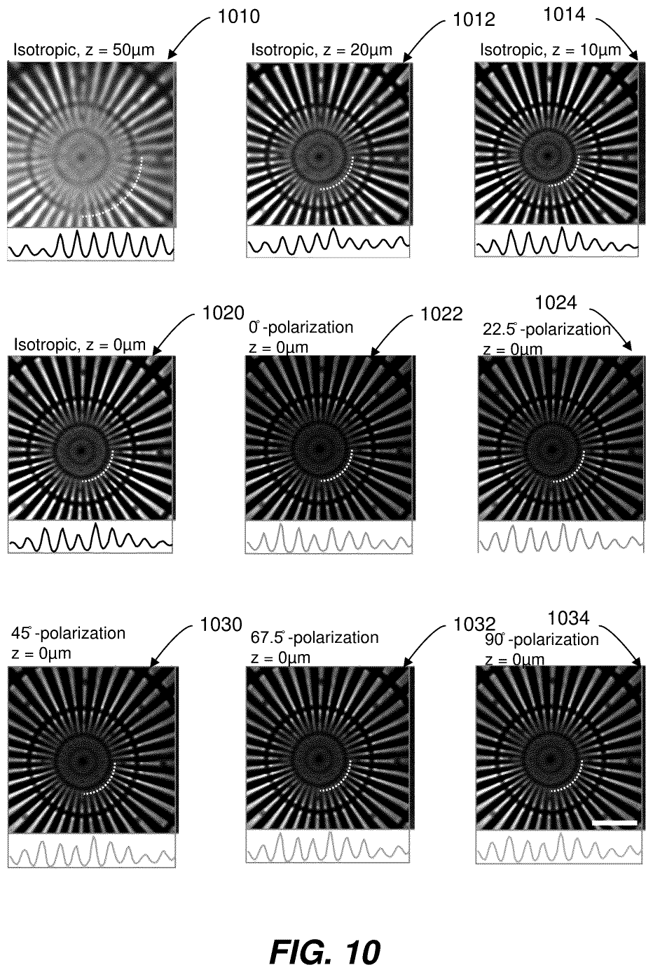

FIG. 10 includes reconstructed pFLF images 1010, 1012, 1014, 1020, 1022, 1024, 1030, 1032, and 1034 of a fluorescent Siemens star under in-focus, varying defocus, and fluorescence polarizations of 0°, 22.5°, 45°, 67.5°, and 90° polarization angles, according to an embodiment. The images in FIG. 10 shows representative reconstruction results and line profiles near the resolution limit. Reconstructed images 1010, 1012, 1014, and 1020 include results from isotropic fluorescence. Reconstructed images 1022, 1024, 1030, 1032, and 1034 include results from fluorescence polarizations at 0°, 22.5°, 45°, 67.5°, and 90° polarization angles. When comparing the image 1020 of the reconstruction of an in-focus Siemens star (z=0) of isotropic fluorescence, the image 1014 with a defocus of z=10-μm shows no resolution degradation, whereas the image 1012 with a z=20-μm defocus leads to slightly reduced resolution. At z=50-μm, the image 1010 shows an evident blur induced by the defocus. For the reconstructions of an in-focus Siemens star with linearly polarized fluorescence shown in reconstructed images 1022, 1024, 1030, 1032, and 1034, the results show polarization measurements that align with the ground truth. Further, the resolution remains consistent with that observed in reconstructions from isotropic fluorescence. This consistency demonstrates robustness of the pFLF imaging system 200 in handling varied fluorescence polarizations.

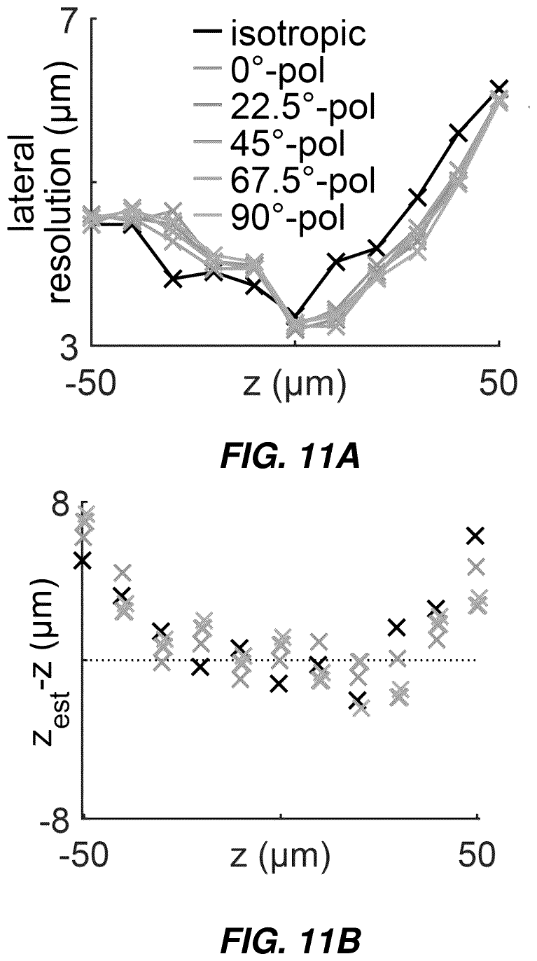

FIG. 11A is a plot of the lateral resolution at different z-depths for various fluorescence polarizations, according to an embodiment. The quantitative analysis results shown in FIG. 11A further support the above results. For example, the in-focus resolution is 3.4 μm for isotropic fluorescence and z=3.2 μm, 3.2 μm, 3.2 μm, 3.3 μm, and 3.3 μm for linearly polarized fluorescence at 0°, 22.5°, 45°, 67.5°, and 90° polarization angles respectively. These values are slightly larger than the sampling limit of 2.6 μm in the example implementation of the pFLF imaging system 200 (i.e., the pixel size is 1.3 μm at the object plane). Notably, the resolution remains below 4.2 μm over a depth of field of ~50 μm for all polarizations. This depth of field significantly exceeds the specification of the objective lens, which is 1.72 μm in this implementation.

Additionally, the depth accuracy was evaluated by comparing the difference between the estimated depth (Zₑₛₜ) and the ground truth (z). FIG. 11B is a plot of estimation bias (Zₑₛₜ-Z) as a function of defocus for isotropic fluorescence and linearly-polarized fluorescence at different polarizations angles, according to an embodiment. Within |z|≤30 μm, the pFLF imaging system 200 of this implementation exhibited high estimation accuracy, with an average absolute bias |zₑₛₜ−z| of 0.9 μm and a maximum of 2.4 μm across all polarizations. However, beyond this range, the absolute bias increased, averaging of 5.2 μm with a maximum reaching 7.4 μm for |z|=50 μm.

### Plant Root Demonstration

Leveraged by its 5D imaging capability, the example implementation of the pFLF imaging system 200 in FIG. 2 described above with respect to the Siemens star demonstration was used to image plant roots, revealing distinct cellulose fibril configurations within various regions of the roots. These results demonstrate the feasibility of 5D single-shot imaging and underscore its biological relevance by providing unprecedented insights into the structural organization and orientation of cellular components.

In this demonstration, the roots of common wheat (Triticum aestivum) were imaged. To demonstrate one of the biological applications of pFLF techniques, the example implementation of the pFLF imaging system 200b was used to image the plant roots stained with Congo Red, a widely used fluorescent dye that binds to 1,4-glucans. Its emission dipole aligns with the cellulose fibrils in plant cells, exhibiting strong polarization features. This property makes it particularly effective for revealing the orientation of cellulosic fibers in various plant species. The wheat roots were treated with 1 M KOH overnight, then rinsed with 0.1 M HCl before being incubated in a 1% Congo Red solution in water overnight. These prepared samples were then imaged.

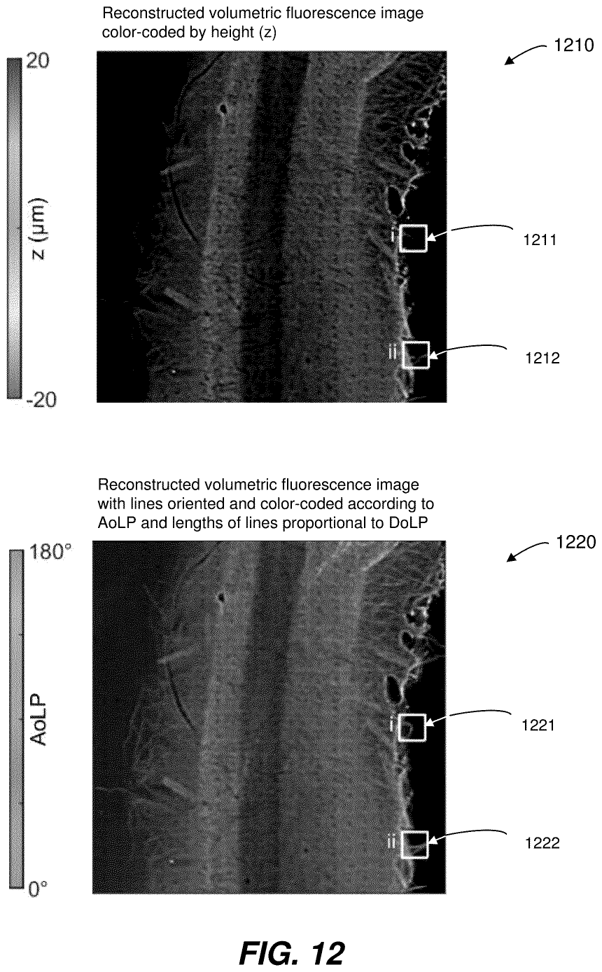

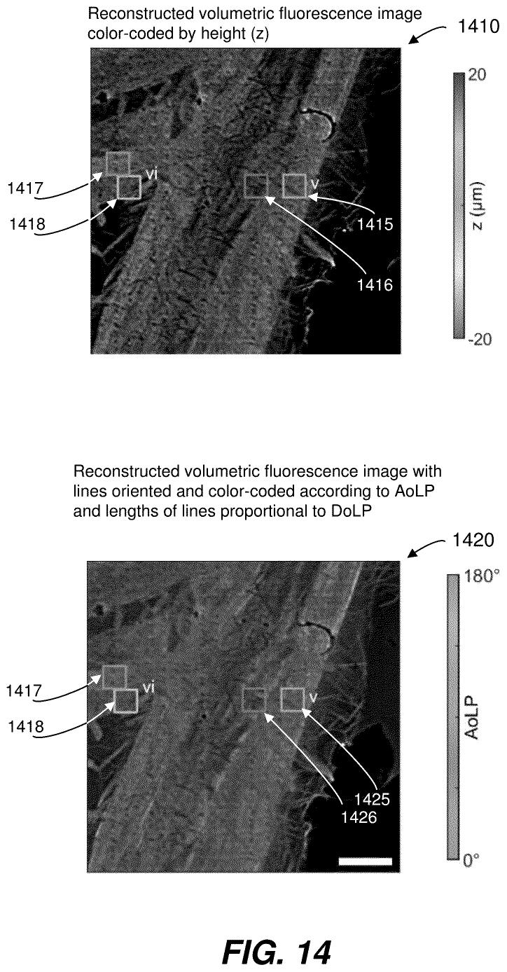

FIGS. 12-14 includes reconstructed images 1210, 1220, 1310, 1320, 1410, and 1420 of the wheat root sections, according to an implementation. The reconstructed images 1210, 1310, and 1410 were color-coded by height. The reconstructed images 1220, 1320, and 1420 were color-coded by polarization. Reconstructed image 1210 includes a first (i) boxed-in region 1211 and reconstructed image 1220 includes a corresponding first (i) boxed-in region 1221. Reconstructed image 1210 also includes a second (ii) boxed-in region 1212 and reconstructed image 1220 includes a corresponding second (ii) boxed-in region 1221. Reconstructed image 1310 includes a (iii) third boxed-in region 1313 and reconstructed image 1320 includes a corresponding (iii) third boxed-in region 1323. Reconstructed image 1310 also includes a fourth (iv) boxed-in region 1314 and reconstructed image 1320 includes a corresponding fourth (iv) boxed-in region 1324.

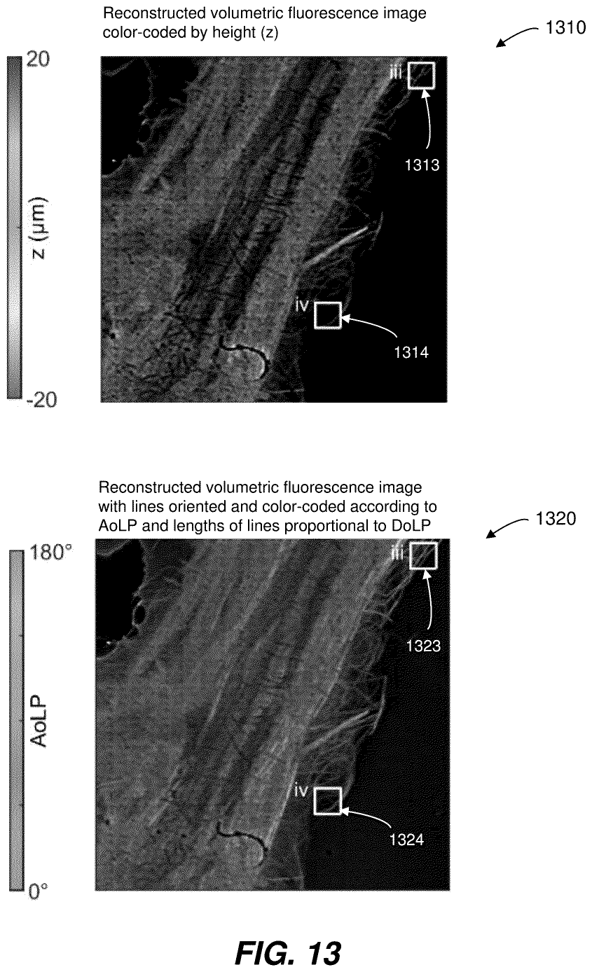

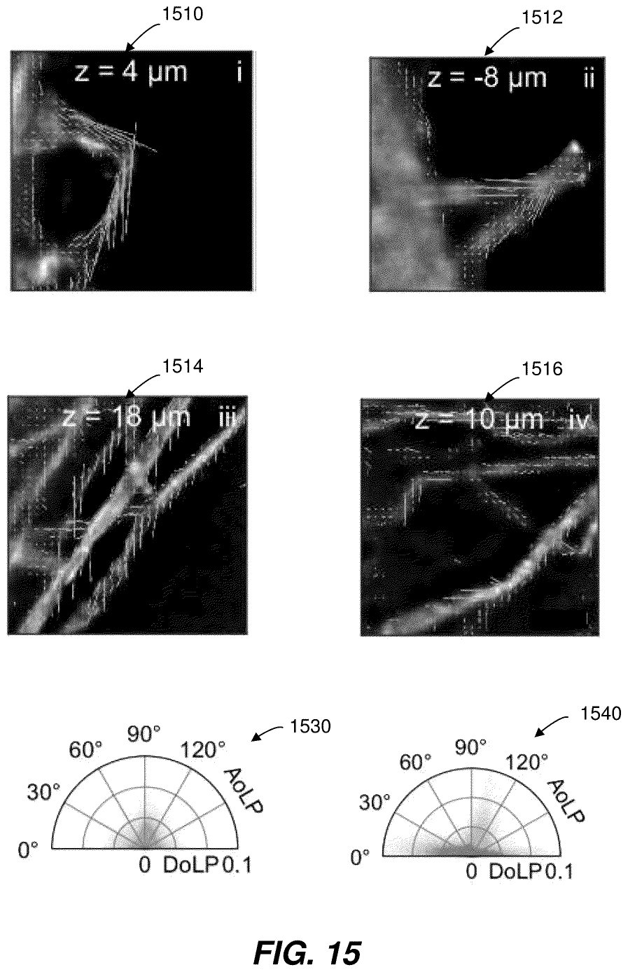

FIG. 15 includes images 1510, 1512, 1514, and 1516 of the zoomed in regions in FIGS. 12 and 13 at the sharpest focal depths. Image 1510 is a zoomed-in view of the first boxed-in region 1211, 1221 in images 1210 and 1220 at a focal depth of z=4 μm. Image 1512 is a zoomed-in view of the second boxed-in region 1212, 1222 in images 1210 and 1220 at a focal depth of z=−8 μm. Image 1514 is a zoomed-in view of third boxed-in region 1313, 1323 in images 1310 and 1320 at a focal depth of z=18 μm. Image 1516 is a zoomed-in view of fourth boxed-in region 1314, 1324 in images 1310 and 1320 at a focal depth of z=10 μm. Lines are oriented and color-coded according to the AoLP and their lengths are proportional to the DoLP. The variations in the heights of the root hair structures can be observed in the representative zoomed in regions at z=4,-8, 18, and 10 μm. FIG. 15 also includes plots 1530, 1540 of the distributions of the AoLP and DoLP for the zoomed-in regions 1510, 1512, 1514, and 1516. In these illustrations, the azimuthal direction (along the semicircle circumference) represents AoLP and the radial direction represents DoLP (with increasing radius corresponding to higher DoLP).

Polarization measurements in the root hair region indicate that the direction of polarization is predominantly parallel to the orientation of the root hairs as shown in the images 1510, 1512, 1514, and 1516, suggesting that the cellulose fibrils are aligned with these structures. Notably, in the primary root, distinct polarization features are observed between the center and outer regions; the polarization in the outer region is mostly parallel to the root, whereas in the center, it appears perpendicular as shown in illustration 1540 in FIG. 15. This suggests different cellulose fibril organizations within these two areas. A similar variation in polarization is also observed in a secondary root branch, although the differences appear more subtle as shown in illustration 1530 in FIG. 15.

Certain embodiments pertain to pFLF imaging techniques that involve 5D single-shot fluorescence imaging that not only captures the 3D fluorescence intensity distribution but also measures the angle and degree of linear polarization of the fluorescence in a single snapshot. In various embodiments, the pFLF imaging systems may maintain consistent resolution across various polarizations and extends the depth of field significantly compared to that of conventional 2D widefield microscopy. Its 5D imaging capability has be demonstrated to enable revealing detailed structural heterogeneities within wheat root sections. These results provide deeper insights into plant cell architecture, which demonstrates the potential of pFLF imaging techniques to contribute to the fields of biological and environmental sciences.

### IV. Computational Systems

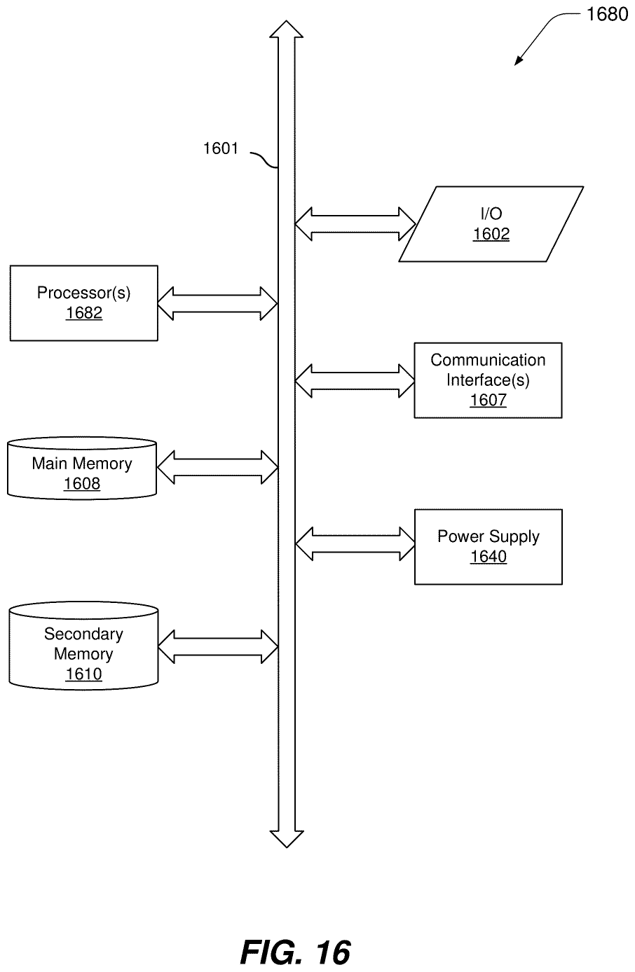

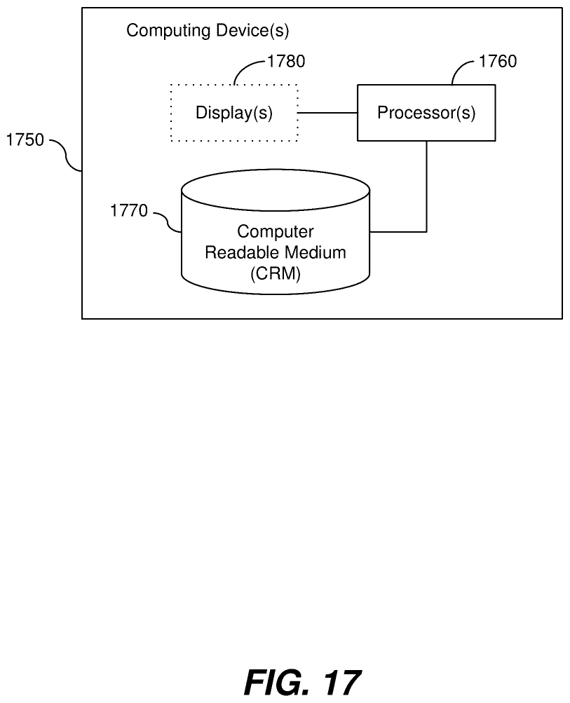

The pFLF techniques described above may be implemented using one or more computing devices. FIGS. 16 and 17 illustrate examples of computing devices that may be used, e.g., to implement functions of pFLF imaging methods described herein.

In FIG. 16, the computing device(s) 1680 includes a bus 1601 coupled to an input/output (I/O) subsystem 1602, one or more processors 1682, one or more communication interfaces 1607, a main memory 1608, a secondary memory 1610, and a power supply 1640. One or more of these components may be in separate housing. According to certain implementations, the illustrated components may be examples of components that are part of computing device(s) 194 or 294 in FIGS. 1 and 2. Computing device 1680 includes I/O subsystem 1602, which includes, or is in communication with, one or more components which may implement an interface for interacting with human users and/or other computer devices depending upon the application.

Certain embodiments disclosed herein may be implemented in program code on computing device 1680 with I/O subsystem 1602 used to receive input program statements and/or data from a human user (e.g., via a graphical user interface (GUI), a keyboard, touchpad, etc.) and to display them back to the user, for example, on a display. The I/O subsystem 1602 may include, e.g., a keyboard, mouse, graphical user interface, touchscreen, or other interfaces for input, and, e.g., an LED or other flat screen display, or other interfaces for output. Other elements of embodiments may be implemented with a computer system like that of computer system 1600 without I/O subsystem 1602. According to various embodiments, a processor may include a CPU, GPU or computer, analog and/or digital input/output connections, controller boards, etc.

Program code may be stored in non-transitory computer readable media such as secondary memory 1610 or main memory 1608 or both. One or more processors 1604 may read program code from one or more non-transitory media and execute the code to enable computing device 1680 to accomplish the methods performed by various embodiments described herein, such as pFLF imaging methods. Those skilled in the art will understand that the one or more processors 1682 may accept source code and interpret or compile the source code into machine code that is understandable at the hardware gate level of the one or more processors 1682.

Communication interfaces 1607 may include any suitable components or circuitry used for communication using any suitable communication network (e.g., the Internet, an intranet, a wide-area network (WAN), a local-area network (LAN), a wireless network, a virtual private network (VPN), and/or any other suitable type of communication network). For example, communication interfaces 1607 can include network interface card circuitry, wireless communication circuitry, etc.

In certain embodiments, computing device 1680 may be part of or connected to a controller that is employed to control functions of various system components described herein. For example, computing device 1680 may control recording of signals by a polarized camera and/or delivery of energy by at least one energy source. The controller will typically include one or more memory devices and one or more processors. The processor may include a CPU or computer, analog and/or digital input/output connections, stepper motor controller boards, etc.

In FIG. 17, the computing device(s) 1750 includes one or more processors 1760 (e.g., microprocessors), a non-transitory computer readable medium (CRM) 1770 in communication with the processor(s) 1760, and one or more displays 1780 also in communication with processor(s) 1760. Processor(s) 1760 is in electronic communication with CRM 1770 (e.g., memory). Processor(s) 1760 is also in electronic communication with display(s) 1780, e.g., to display image data, text, etc. on display 1780. Processor(s) 1760 may retrieve and execute instructions stored on the CRM 1770 to perform one or more functions described above. For example, processor(s) 1760 may execute instructions to perform one or more operations to acquire raw images, reconstruct volumetric fluorescence images, etc. The CRM (e.g., memory) 1770 can store instructions for performing one or more functions of the described above. These instructions may be executable by processor(s) 1760. CRM 1770 can also store raw images, e.g., microscopy images, polarized sub-images from a raw image, or the like.

Many types of computing devices having any of various computer architectures may be employed as the disclosed systems for implementing algorithms. For example, the computing devices may include software components executing on one or more general purpose processors or specially designed processors such as Application Specific Integrated Circuits (ASICs) or programmable logic devices (e.g., Field Programmable Gate Arrays (FPGAs)). Further, the systems may be implemented on a single device or distributed across multiple devices. The functions of the computational elements may be merged into one another or further split into multiple sub-modules.

At one level a software element is implemented as a set of commands prepared by the programmer/developer. However, the module software that can be executed by the computer hardware is executable code committed to memory using “machine codes” selected from the specific machine language instruction set, or “native instructions,” designed into the hardware processor. The machine language instruction set, or native instruction set, is known to, and essentially built into, the hardware processor(s). This is the “language” by which the system and application software communicates with the hardware processors. Each native instruction is a discrete code that is recognized by the processing architecture and that can specify particular registers for arithmetic, addressing, or control functions; particular memory locations or offsets; and particular addressing modes used to interpret operands. More complex operations are built up by combining these simple native instructions, which are executed sequentially, or as otherwise directed by control flow instructions.

The inter-relationship between the executable software instructions and the hardware processor is structural. In other words, the instructions per se are a series of symbols or numeric values. They do not intrinsically convey any information. It is the processor, which by design was preconfigured to interpret the symbols/numeric values, which imparts meaning to the instructions.

The algorithms used herein may be configured to execute on a single machine at a single location, on multiple machines at a single location, or on multiple machines at multiple locations. When multiple machines are employed, the individual machines may be tailored for their particular tasks. For example, operations requiring large blocks of code and/or significant processing capacity may be implemented on large and/or stationary machines.

In addition, certain embodiments relate to tangible and/or non-transitory computer readable media or computer program products that include program instructions and/or data (including data structures) for performing various computer-implemented operations. Examples of computer-readable media include, but are not limited to, memory devices, phase-change devices, magnetic media such as disk drives, magnetic tape, optical media such as CDs, magneto-optical media, and hardware devices that are specially configured to store and perform program instructions, such as read-only memory devices (ROM) and random access memory (RAM). The computer readable media may be directly controlled by an end user or the media may be indirectly controlled by the end user. Examples of directly controlled media include the media located at a user facility and/or media that are not shared with other entities. Examples of indirectly controlled media include media that is indirectly accessible to the user via an external network and/or via a service providing shared resources such as the “cloud.” Examples of program instructions include both machine code, such as produced by a compiler, and files containing higher level code that may be executed by the computer using an interpreter.

In some embodiments, code executed during generation or execution of various models on an appropriately programmed system can be embodied in the form of software elements which can be stored in a nonvolatile storage medium (such as optical disk, flash storage device, mobile hard disk, etc.), including a number of instructions for making a computing device (such as personal computers, servers, network equipment, etc.). In various embodiments, the data or information employed in the disclosed methods and apparatus is provided in an electronic format. Such data or information may include design layouts, fixed parameter values, floated parameter values, feature profiles, metrology results, and the like. As used herein, data or other information provided in electronic format is available for storage on a machine and transmission between machines. Conventionally, data in electronic format is provided digitally and may be stored as bits and/or bytes in various data structures, lists, databases, etc. The data may be embodied electronically, optically, etc.

### EXAMPLE EMBODIMENTS

Embodiment 1: A polarized Fourier light-field imaging system, comprising: a first optical system in optical communication with one or more light sources, the first optical system configured to deliver polarized excitation illumination to a sample being imaged, the sample issuing fluorescence emissions induced by the polarized excitation illumination, the first optical system comprising a microlens array at a pupil plane, the microlens array comprising a plurality of lenslets configured to segment fluorescence emissions issuing from the sample from different angles; a second optical system in optical communication with the microlens array, the second optical system configured to convert the fluorescence emissions into spatial frequencies in the Fourier domain; and a polarization sensor in optical communication with the second optical system, the polarization sensor configured to acquire one or more raw images, each raw image including a plurality of polarized sub-images corresponding to a respective plurality of polarization channels.

Embodiment 2: The polarized Fourier light-field imaging system of embodiment 1, further comprising an iris at an intermediate image plane, the iris configured to set a field-of view of each of the polarized sub-images.

Embodiment 3: The polarized Fourier light-field imaging system of embodiment 2, wherein the iris is configured to separate the polarized sub-images.

Embodiment 4: The polarized Fourier light-field imaging system of embodiment 1, wherein each polarization channel includes intensities captured at polarized pixels of one of a plurality of polarization angles.

Embodiment 5: The polarized Fourier light-field imaging system of embodiment 4, wherein the plurality of polarizations angles comprises a 0° polarization angle, a 45° polarization, a 90° polarization angle, and a 135° polarization angle.

Embodiment 6: The polarized Fourier light-field imaging system of embodiment 1, wherein the first optical system comprises one or more optical fibers in optical communication with the one or more light sources.

Embodiment 7: The polarized Fourier light-field imaging system of embodiment 1, wherein the lenslets of the microlens array have different focal lengths.

Embodiment 8: The polarized Fourier light-field imaging system of embodiment 1, wherein the first optical system comprises an objective lens configured to deliver the polarized excitation illumination to the sample being imaged and configured to receive the fluorescence emissions from the sample.

Embodiment 9: The polarized Fourier light-field imaging system of embodiment 1, wherein the second optical system comprising a plurality of lens in a 4f optical configuration.

Embodiment 10: The polarized Fourier light-field imaging system of embodiment 1, wherein the second optical system comprising a plurality of lens in a 4f optical configuration.

Embodiment 11: A polarized Fourier light-field imaging method, comprising: (a) obtaining a raw image of a sample using a polarization camera, the raw image including a plurality of polarized two-dimensional (2D) sub-images corresponding to a plurality of polarization channels associated with polarization angles of polarized pixels of the polarization camera, the raw image acquired based on fluorescence emissions emitted from fluorophores in the sample in response to activation by polarized excitation illumination; (b) applying a 2D-to-3D reconstruction procedure to the plurality of 2D polarized sub-images to generate a corresponding plurality of three-dimensional (3D) volumetric datasets; and (c) applying voxel-wise combination of the plurality of 3D volumetric datasets based on Stokes relationships to generate a volumetric fluorescence image.

Embodiment 12: The polarized Fourier light-field imaging method of embodiment 11, wherein the volumetric fluorescence image comprises 3D fluorescence intensity data and polarization parameter data.

Embodiment 13: The polarized Fourier light-field imaging method of embodiment 12, wherein the polarization parameter data comprises angle of linear polarization and/or a degree of linear polarization.

Embodiment 14: The polarized Fourier light-field imaging method of embodiment 11, wherein each 3D volumetric dataset corresponds to one of the polarization channels.

Embodiment 15: The polarized Fourier light-field imaging method of embodiment 11, further comprising causing delivery of the polarized excitation illumination to the sample being imaged.

Embodiment 16: The polarized Fourier light-field imaging method of embodiment 11, further comprising causing the polarization camera to acquire and record the raw image.

Embodiment 17: The polarized Fourier light-field imaging method of embodiment 11, wherein the polarization angles comprise a 0° polarization angle, a 45° polarization, a 90° polarization angle, and a 135° polarization angle.

Embodiment 18: The polarized Fourier light-field imaging method of embodiment 11, further comprising repeating (a), (b), and (c) for one or more additional raw images to generate additional volumetric fluorescence images.

Embodiment 19: The polarized Fourier light-field imaging method of embodiment 11, wherein the 2D polarized sub-images do not overlap.

Embodiment 20: The polarized Fourier light-field imaging system of embodiment 11, further comprising separating the 2D polarized sub-images.

Embodiment 21: The polarized Fourier light-field imaging system of embodiment 11, wherein the 2D-to-3D reconstruction procedure comprises a Richardson-Lucy (RL) deconvolution procedure, a sparsity-regularized RL deconvolution procedure, or a neural fields representation procedure.

Embodiment 22: A non-transitory machine-readable medium comprising instructions that, when executed by one or more processors, are configured to cause the one or more processors to perform operations comprising: (a) obtaining a raw image of a sample using a polarization camera, the raw image including a plurality of polarized two-dimensional (2D) sub-images corresponding to a plurality of polarization channels associated with polarization angles of polarized pixels of the polarization camera, the raw image acquired based on fluorescence emissions emitted from fluorophores in the sample in response to activation by polarized excitation illumination; (b) applying a 2D-to-3D reconstruction procedure to the plurality of polarized 2D sub-images to generate a corresponding plurality of three-dimensional (3D) volumetric datasets; and (c) applying voxel-wise combination of the plurality of 3D volumetric datasets based on Stokes relationships to generate a volumetric fluorescence image.

Modifications, additions, or omissions may be made to any of the above-described embodiments without departing from the scope of the disclosure. Any of the embodiments described above may include more, fewer, or other features without departing from the scope of the disclosure. Additionally, the steps of described features may be performed in any suitable order without departing from the scope of the disclosure. Also, one or more features from any embodiment may be combined with one or more features of any other embodiment without departing from the scope of the disclosure. The components of any embodiment may be integrated or separated according to particular needs without departing from the scope of the disclosure.

It should be understood that certain aspects described above can be implemented in the form of logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code using any suitable computer language and/or computational software such as, for example, Java, C, C#, C++ or Python, Lab VIEW, Mathematica, or other suitable language/computational software, including low level code, including code written for field programmable gate arrays, for example in VHDL. The code may include software libraries for functions like data acquisition and control, motion control, image acquisition and display, etc. Some or all of the code may also run on a personal computer, single board computer, embedded controller, microcontroller, digital signal processor, field programmable gate array and/or any combination thereof or any similar computation device and/or logic device(s). The software code may be stored as a series of instructions, or commands on a CRM such as a random access memory (RAM), a read only memory (ROM), a magnetic media such as a hard-drive or a floppy disk, or an optical media such as a CD-ROM, or solid stage storage such as a solid state hard drive or removable flash memory device or any suitable storage device. Any such CRM may reside on or within a single computational apparatus, and may be present on or within different computational apparatuses within a system or network. Although the foregoing disclosed embodiments have been described in some detail to facilitate understanding, the described embodiments are to be considered illustrative and not limiting. It will be apparent to one of ordinary skill in the art that certain changes and modifications can be practiced within the scope of the appended claims.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

What is claimed is:

1. A polarized Fourier light-field imaging system, comprising:
a first optical system in optical communication with one or more light sources, the first optical system configured to deliver polarized excitation illumination to a sample being imaged, the sample issuing fluorescence emissions induced by the polarized excitation illumination, the first optical system comprising a microlens array at a pupil plane, the microlens array comprising a plurality of lenslets configured to segment fluorescence emissions issuing from the sample from different angles;
a second optical system in optical communication with the microlens array, the second optical system configured to convert the fluorescence emissions into spatial frequencies in the Fourier domain; and
a polarization sensor in optical communication with the second optical system, the polarization sensor configured to acquire one or more raw images, each raw image including a plurality of polarized sub-images corresponding to a respective plurality of polarization channels.

2. The polarized Fourier light-field imaging system of claim 1, further comprising an iris at an intermediate image plane, the iris configured to set a field-of view of each of the polarized sub-images.

3. The polarized Fourier light-field imaging system of claim 2, wherein the iris is configured to separate the polarized sub-images.

4. The polarized Fourier light-field imaging system of claim 1, wherein each polarization channel includes intensities captured at polarized pixels of one of a plurality of polarization angles.

5. The polarized Fourier light-field imaging system of claim 4, wherein the plurality of polarizations angles comprises a 0° polarization angle, a 45° polarization, a 90° polarization angle, and a 135° polarization angle.

6. The fluorescence imaging system of claim 1, wherein the lenslets of the microlens array have different focal lengths.

7. The fluorescence imaging system of claim 1, wherein the first optical system comprises an objective lens configured to deliver the polarized excitation illumination to the sample being imaged and configured to receive the fluorescence emissions from the sample.

8. The fluorescence imaging system of claim 1, wherein the second optical system comprising a plurality of lens in a 4f optical configuration.

9. A polarized Fourier light-field imaging method, comprising:
(a) obtaining a raw image of a sample using a polarization camera, the raw image including a plurality of polarized two-dimensional (2D) sub-images corresponding to a plurality of polarization channels associated with polarization angles of polarized pixels of the polarization camera, the raw image acquired based on fluorescence emissions emitted from fluorophores in the sample in response to activation by polarized excitation illumination;
(b) applying a 2D-to-3D reconstruction procedure to the plurality of 2D polarized sub-images to generate a corresponding plurality of three-dimensional (3D) volumetric datasets; and
(c) applying voxel-wise combination of the plurality of 3D volumetric datasets based on Stokes relationships to generate a volumetric fluorescence image.

10. The polarized Fourier light-field imaging method of claim 9, wherein the volumetric fluorescence image comprises 3D fluorescence intensity data and polarization parameter data.

11. The polarized Fourier light-field imaging method of claim 10, wherein the polarization parameter data comprises angle of linear polarization and/or a degree of linear polarization.

12. The polarized Fourier light-field imaging method of claim 9, wherein each 3D volumetric dataset corresponds to one of the polarization channels.

13. The polarized Fourier light-field imaging method of claim 9, further comprising:
causing delivery of the polarized excitation illumination to the sample being imaged; and/or
causing the polarization camera to acquire and record the raw image.

14. The polarized Fourier light-field imaging method of claim 9, wherein the polarization angles comprise a 0° polarization angle, a 45° polarization, a 90° polarization angle, and a 135° polarization angle.

15. The polarized Fourier light-field imaging method of claim 9, further comprising repeating (a), (b), and (c) for one or more additional raw images to generate additional volumetric fluorescence images.

16. The polarized Fourier light-field imaging method of claim 9, wherein the 2D polarized sub-images do not overlap.

17. The polarized Fourier light-field imaging method of claim 9, further comprising separating the 2D polarized sub-images.

18. The polarized Fourier light-field imaging method of claim 9, wherein the 2D-to-3D reconstruction procedure comprises a Richardson-Lucy (RL) deconvolution procedure, a sparsity-regularized RL deconvolution procedure, or a neural fields representation procedure.

19. The polarized Fourier light-field imaging method of claim 9, wherein the volumetric fluorescence image is a color image.

20. A non-transitory machine-readable medium comprising instructions that, when executed by one or more processors, are configured to cause the one or more processors to perform operations comprising:
(a) obtaining a raw image of a sample using a polarization camera, the raw image including a plurality of polarized two-dimensional (2D) sub-images corresponding to a plurality of polarization channels associated with polarization angles of polarized pixels of the polarization camera, the raw image acquired based on fluorescence emissions emitted from fluorophores in the sample in response to activation by polarized excitation illumination;
(b) applying a 2D-to-3D reconstruction procedure to the plurality of polarized 2D sub-images to generate a corresponding plurality of three-dimensional (3D) volumetric datasets; and
(c) applying voxel-wise combination of the plurality of 3D volumetric datasets based on Stokes relationships to generate a volumetric fluorescence image.
